(19) United States
(12) Patent Application Publication
(10) Pub. No.: US 2025/0155694 A1
(43) Pub. Date: May 15, 2025

(54) ZOOM LENS AND IMAGE PICKUP APPARATUS

(71) Applicant: CANON KABUSHIKI KAISHA, Tokyo (JP)

(72) Inventor: Junya ICHIMURA, Tochigi (JP)

(21) Appl. No.: 18/915,438

(22) Filed: Oct. 15, 2024

(30) Foreign Application Priority Data
Nov. 14, 2023 (JP) 2023-193613

(51) Int. Cl. G02B 15/14; G02B 15/167

(52) U.S. Cl. CPC G02B 15/1461; G02B 15/167

(57) ABSTRACT

A zoom lens includes, in order from an object side to an image side, a front group consisting of a first lens unit having positive refractive power and a plurality of intermediate lens units, the plurality of intermediate lens units including one or more lens units having negative refractive power, and a rear group consisting of an aperture stop and lens units. During zooming, the first lens unit and the lens unit closest to an object in the rear group are fixed and each intermediate lens unit moves toward the image side, a distance between adjacent lens units among lens units included in the front group and the lens unit closest to the object in the rear group changes. The rear group includes first and second focus lens units that move moving during focusing. Predetermined inequalities are satisfied.

### BACKGROUND

### Technical Field

The present disclosure relates to an image pickup apparatus, such as a digital camera and a video camera.

### Description of Related Art

In a zoom lens, a moving lens unit is demanded to have a reduced size in order to suppress changes in a center of gravity along with the movement of the lens unit during zooming and to reduce the torque for driving the lens unit. In addition, during focusing, an angle of view is to change little, i.e., focus breathing is to be reduced, and a moving lens unit (focus unit) is demanded to have a reduced size.

In a telephoto zoom lens with a large aperture diameter, the refractive power of the first lens unit closest to the object is generally positive. In this case, by fixing the first lens unit, which is the heaviest lens unit, for rear focusing, the weights of lens units configured to move during zooming and focusing can be reduced. In addition, since a change in an angle of view caused by focus breathing is more noticeable in a narrow aperture state, focus breathing is to be reduced in a case where the aperture is narrowed.

However, in an attempt to secure a sufficient peripheral light amount while the diameter of the first lens unit is kept small in order to achieve a compact and lightweight zoom lens as a whole, a so-called one-sided aperture state is likely to occur, in which a principal ray of a peripheral light beam is shifted from the center of the aperture stop. In a case where the aperture is narrowed in the one-sided aperture state, focus breathing is likely to increase as lens units on the image side of the aperture stop move.

### SUMMARY

A zoom lens according to one aspect of the disclosure includes, in order from an object side to an image side, a front group consisting of a first lens unit having positive refractive power and a plurality of intermediate lens units, the plurality of intermediate lens units including one or more lens units having negative refractive power, and a rear group consisting of an aperture stop and a plurality of lens units. During zooming from a wide-angle end to a telephoto end, the first lens unit and the lens unit closest to an object in the rear group are fixed and each of the plurality of intermediate lens units moves toward the image side, a distance between adjacent lens units among lens units included in the front group and the lens unit closest to the object in the rear group changes. The rear group includes a first focus lens unit and a second focus lens unit disposed on the image side of the first focus lens unit, the first focus lens unit and the second focus lens unit moving during focusing. The following inequalities are satisfied:

$$0.2 \leq fF 2 / fF 1 \leq 2.$$

$$- 3 \leq fFw / fw < 0$$

where fF1 is a focal length of the first focus lens unit, fF2 is a focal length of the second focus lens unit, fFw is a focal length of the front group at the wide-angle end, and fw is a focal length of the zoom lens at the wide-angle end. An image pickup apparatus having the above zoom lens also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of a zoom lens according to Example 1.

FIG. 2 is a sectional view of a zoom lens according to Example 2.

FIG. 3 is a sectional view of a zoom lens according to Example 3.

FIG. 4 is a sectional view of a zoom lens according to Example 4.

FIG. 5 is a sectional view of a zoom lens according to Example 5.

FIG. 6 is a sectional view of a zoom lens according to Example 6.

FIGS. 7A and 7B are longitudinal aberration diagrams at a wide-angle end and a telephoto end of the zoom lens according to Example 1, respectively.

FIGS. 8A and 8B are longitudinal aberration diagrams at a wide-angle end and a telephoto end of the zoom lens according to Example 2, respectively.

FIGS. 9A and 9B are longitudinal aberration diagrams at a wide-angle end and a telephoto end of the zoom lens according to Example 3, respectively.

FIGS. 10A and 10B are longitudinal aberration diagrams at a wide-angle end and a telephoto end of the zoom lens according to Example 4, respectively.

FIGS. 11A and 11B are longitudinal aberration diagrams at a wide-angle end and a telephoto end of the zoom lens according to Example 5, respectively.

FIGS. 12A and 12B are longitudinal aberration diagrams at a wide-angle end and a telephoto end of the zoom lens according to Example 6, respectively.

FIG. 13 is a schematic diagram of an image pickup apparatus including the zoom lens according to any one of Examples 1 to 6.

### DETAILED DESCRIPTION

Referring now to the accompanying drawings, a description will be given of examples according to the disclosure.

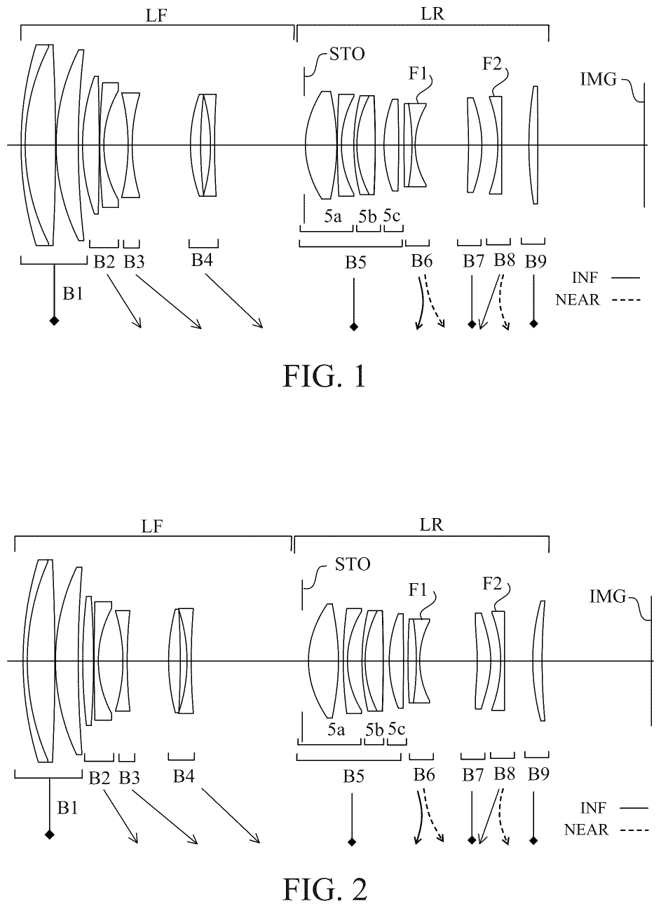

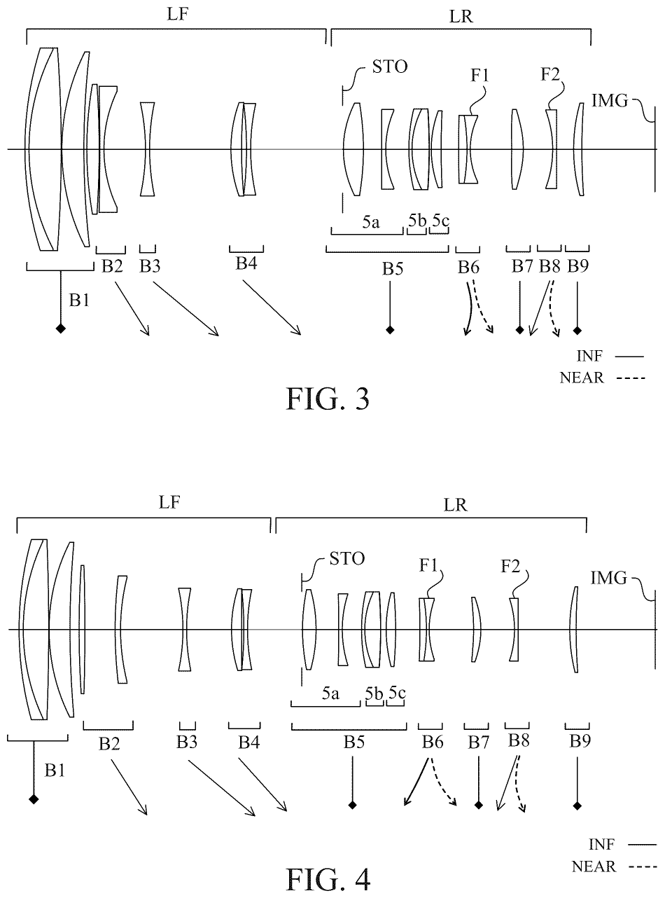

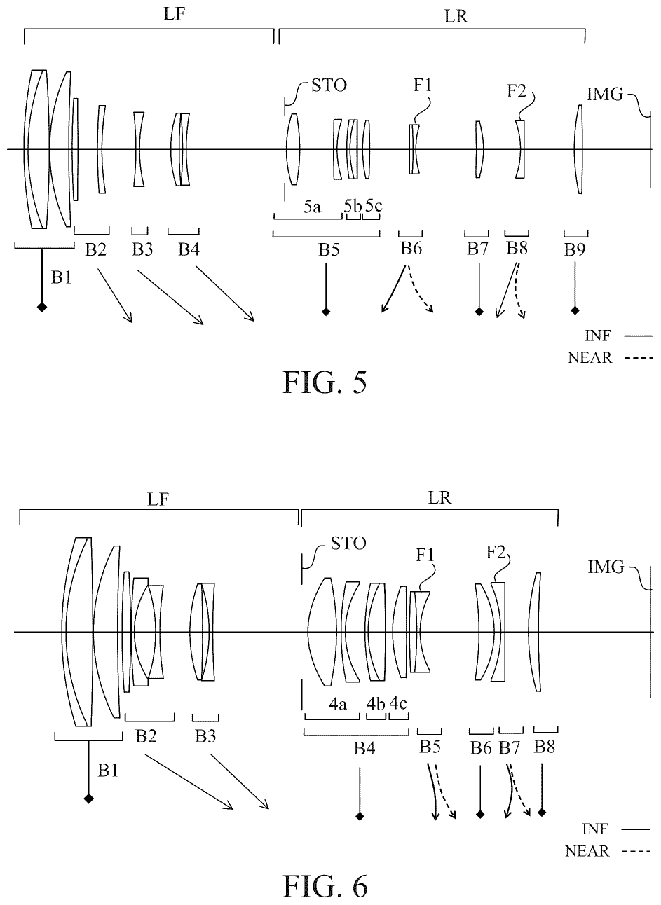

FIGS. 1, 2, 3, 4, 5, and 6 illustrate the configurations of zoom lenses according to Examples 1 to 6 in an in-focus state on an object at infinity. The zoom lens according to each example is used for various image pickup apparatuses such as digital video cameras, digital still cameras, broadcasting cameras, film-based cameras, and surveillance cameras.

In each figure, a left side is an object side and a right side is an image side. img represents an image plane. An imaging surface (light receiving surface) of the image sensor and a film surface (photosensitive surface) of the silver film are disposed on the image plane.

In a zoom lens, a lens unit is a group of one or more lenses that integrally move or stand still during magnification variation (zooming) between the wide-angle end and the telephoto end. In other words, a distance between adjacent lens units changes during zooming. In each figure, an i-th lens unit counted from the object side is designated by a lens unit Bi. The lens unit may include an aperture stop. The wide-angle end and the telephoto end respectively indicate a maximum angle of view (shortest focal length) and a minimum angle of view (maximum focal length) in a case where the lens unit that moves during zooming is located at both ends of a mechanically or controllably movable range on the optical axis.

In each figure, STO represents an aperture stop (diaphragm). The aperture stop STO determines a light beam at the maximum F-number (Fno), and its aperture diameter is variable to change a depth of field. Lens units on the object side of the aperture stop STO will be collectively referred to as a front group LF, and lens units on the image side of the front group LF including the aperture stop STO will be collectively referred to as a rear group LR.

Below each lens unit that moves during zooming, a moving locus during zooming from the wide-angle end to the telephoto end is illustrated with an arrow. Below each lens unit (focus lens unit) that moves during focusing, a moving locus for compensating for the image-plane movement along with zooming in an in-focus state on an object at infinity (INF) and in an in-focus state on an object at a close distance (NEAR) is illustrated with solid and dashed arrows, respectively. The zoom lens according to each example includes two focus units disposed on the image side of the aperture stop STO, of which a first focus lens unit on the object side (referred to as a first focus unit hereinafter) is designated by F1, and a second focus lens unit on the image side (referred to as a second focus unit hereinafter) is designated by F2.

A description will be given of a specific configuration of the zoom lens according to each example. The zoom lens according to each example includes, in order from the object side to the image side, a front group LF consisting of a first lens unit B1 having positive refractive power and a plurality of intermediate lens units including one or more lens units having negative refractive power, and a rear group LR including an aperture stop STO and a plurality of lens units. During zooming, the first lens unit and the final lens unit closest to the image plane are fixed (do not move) relative to the image plane, thereby reducing the change in the center of gravity along with zooming and improving dust resistance.

The lens units included in the intermediate lens units move toward the image side by different moving amounts during zooming from the wide-angle end to the telephoto end, improving the imaging performance at an intermediate zoom position and reducing the weight of each lens unit.

Reducing the weights of the moving lens units can improve the retaining performance in the zoom state and focus state with high performance even when an impact is applied. The intermediate lens units may include three or more lens units, and moving them by different moving amounts can achieve high optical performance throughout the entire zoom range even at a high zoom ratio.

The rear group LR includes a lens unit closest to the object that is fixed during zooming, and an aperture stop STO disposed within this lens unit to prevent an increase in the lens outer diameter. The rear group LR further includes a first focus unit F1 and a second focus unit F2 disposed on the image side of the first focus unit F1, and performs so-called floating focus, which suppresses aberration fluctuations throughout the entire zoom range and all object distances, thereby achieving high optical performance. Each of the first focus unit F1 and the second focus unit F2 moves toward the image side during focusing from an object at infinity to an object at a close distance.

The zoom lens according to each example may satisfy the following inequalities (1) and (2) in order to achieve high optical performance throughout the zoom range and focus range while the zoom lens has a reduced size and weight as a whole, and reduced focus breathing.

$$0.2 \leq fF 2 / fF 1 \leq 2. \qquad ( 1 )$$

$$- 3 \leq fFw / fw < 0 \qquad ( 2 )$$

where fw is a focal length of the zoom lens system at the wide-angle end, fF1 is a focal length of the first focus unit F1, fF2 is a focal length of the second focus unit F2, and fFw is a focal length of the front group LF at the wide-angle end.

Inequality (1) defines a proper relationship between the focal length fF1 of the first focus unit F1 and the focal length fF2 of the second focus unit F2. Satisfying inequality (1) can reduce both focus fluctuation and focus breathing during zooming. In a case where fF2/fF1 becomes higher than the upper limit of inequality (1), the focus sensitivity of the first focus unit F1 becomes too high, the focusing accuracy reduces, and the effect of correcting focus breathing of the second focus unit F2 reduces. In a case where fF2/fF1 becomes lower than the lower limit of inequality (1), the focus sensitivity of the first focus unit F1 becomes too low, a moving amount of the first focus unit F1 increases, and it becomes difficult to reduce the overall length of the zoom lens.

In order to reduce focus breathing, both the first focus unit F1 and the second focus unit F2 may be moved toward the image side during focusing from an object at infinity to an object at a close distance.

Inequality (2) defines a proper relationship between the focal length fFw of the front group LF at the wide-angle end and the focal length fw of the entire zoom lens system at the wide-angle end. Satisfying inequality (2) can direct the incident angle of the on-axis ray on the aperture stop STO to the divergence direction, improve the one-sided aperture over the entire zoom range, and reduce changes in the principal ray in a case where the aperture in the aperture stop STO is narrowed, i.e., changes in the angle of view on the object side. In a case where fFw/fw becomes higher than the upper limit of inequality (2), the incident ray on the aperture stop STO becomes convergent light and the number of lower rays passing through the lower edge of the aperture stop STO reduces. In a case where fFw/fw becomes lower than the lower limit of inequality (2), the divergence of the incident ray on the aperture stop STO becomes too weak, upper rays runs short or the outer diameter of the aperture stop STO (referred to as the outer aperture diameter hereinafter) increases.

Inequalities (1) and (2) may be replaced with inequalities (1a) and (2a) below:

$$0.4 \leq fF 2 / fF 1 \leq 1.5 \qquad ( 1 a )$$

$$- 2.5 \leq fFw / fw \leq - 0.5 \qquad ( 2 a )$$

Inequalities (1) and (2) may be replaced with inequalities (1b) and (2b) below:

$$0.4 \leq fF 2 / fF 1 \leq 1.2 \qquad ( 1 b )$$

$$- 2. \leq fFw / fw \leq - 1. \qquad ( 2 b )$$

The zoom lens according to each example may satisfy at least one of inequalities (3) to (16) below:

$$- 6.5 \leq fFt / f t < 0. \qquad ( 3 )$$

$$- 2. \leq fF 1 / fRa \leq - 0.5 \qquad ( 4 )$$

$$- 2. \leq fF 1 / fi < 0. \qquad ( 5 )$$

$$- 2. \leq fF 2 / fRb \leq - 0.2 \qquad ( 6 )$$

$$0.5 \leq β F 1 t / β F 2 t \leq 3. \qquad ( 7 )$$

$$1.5 \leq \vert besF 1 t \vert / \vert besF 2 t \vert \leq 5. \qquad ( 8 )$$

$$0.4 \leq ST / TTL \leq 0.7 \qquad ( 9 )$$

$$- 30 \leq fFt / fRt < 0 \qquad ( 10 )$$

$$0.4 \leq \vert m F 2 w \vert / \vert m F 1 w \vert \leq 2. \qquad ( 11 )$$

$$0.3 \leq \vert m F 2 t \vert / \vert m F 1 t \vert \leq 2. \qquad ( 12 )$$

$$0.3 \leq SF 2 \leq 3. \qquad ( 13 )$$

$$1.6 \leq NdF 2 \leq 2. \qquad ( 14 )$$

$$0.5 \leq TTL / f t \leq 1.5 \qquad ( 15 )$$

$$0.2 \leq BF / fi \leq 0. 6 \qquad ( 16 )$$

In inequalities (3) to (16), ft is a focal length of the zoom lens system at the telephoto end, fFt is a focal length of the front group LF at the telephoto end, and fRa is a focal length of the lens unit BRa in the rear group LR that is adjacent to and disposed on the object side of the first focus unit F1. fRb is a focal length of the fixed lens unit BRb that is located between the first focus unit F1 and the second focus unit F2 and does not move during zooming or focusing. fi is a focal length of the final lens unit Bi, which is the lens unit closest to the image plane in the zoom lens (rear group LR). βF1t is an imaging magnification of the first focus unit F1 at the telephoto end, and βF2t is an imaging magnification of the second focus unit F2 at the telephoto end. besF1t is a focus sensitivity of the first focus unit F1 at the telephoto end, and besF2t is a focus sensitivity of the second focus unit F2 at the telephoto end. ST is a length on the optical axis from the aperture stop STO to the image plane img, and TTL is a length on the optical axis from a surface closest to the object in the zoom lens (front group LF) to the image plane img (overall lens length). mF1w is a moving amount of the first focus unit F1 during focusing from an object at infinity to an object at close distance at the wide-angle end, and mF2w is a moving amount of the second focus unit F2 during focusing from an object at infinity to an object at a close distance at the wide-angle end. mF1t is a moving amount of the first focus unit F1 during focusing from an object at infinity to an object at a close distance at the telephoto end, and mF2t is a moving amount of the second focus unit F2 during focusing from an object at infinity to an object at a close distance at the wide-angle end. A moving amount of each focus unit is a difference between a position of the focus unit in an in-focus state on an object at infinity and a position of the focus unit in an in-focus state on an object at a close distance. SF2 is a shape factor of one negative lens constituting the second focus unit F2, and NdF2 is a refractive index for the d-line of one negative lens constituting the second focus unit F2. BF is a back focus of the zoom lens, which is the air equivalent length on the optical axis from a surface closest to the image plane of the zoom lens to the image plane.

Inequality (3) defines a proper relationship between the focal length fFt of the front group LF at the telephoto end and the focal length ft of the zoom lens at the wide-angle end. Satisfying inequality (3) can reduce changes in the angle of view when the aperture in the aperture stop STO is narrowed. In a case where fFt/ft becomes higher than the upper limit of inequality (3), the number of lower rays reduces. In a case where fFt/ft becomes lower than the lower limit of inequality (3), the number of upper rays passing through the upper edge of the aperture stop STO runs short or the outer aperture diameter increases.

Inequality (4) defines a proper relationship between the focal length fF1 of the first focus unit F1 and the focal length fRa of the lens unit adjacent to and disposed on the object side of the first focus unit F1, and in particular illustrates a proper focal length of the first focus unit F1. In a case where fF1/fRa becomes higher than the upper limit of inequality (4), the focal length of the first focus unit F1 increases, and it becomes difficult to shorten the closest distance. In a case where fF1/fRa becomes lower than the lower limit of inequality (4), the focal length of the first focus unit F1 reduces, and it reduces focus accuracy.

Inequality (5) defines a proper relationship between the focal length fF1 of the first focus unit F1 and the focal length fi of the lens unit Bi closest to the image plane, and illustrates a condition for obtaining a proper back focus. In a telephoto zoom lens, an extender is often attached to change a focal length range, so a sufficient back focus is to be secured. In a case where fF1/fi becomes higher than the upper limit of inequality (5), the focal length of the final lens unit Bi increases, and it becomes difficult to reduce the size of the first focus unit F1. In a case where fF1/fi becomes lower than the lower limit of inequality (5), the focal length of the first focus unit F1 reduces, and the focus accuracy reduces.

In order to reduce the lens diameter of the first focus unit F1 and its weight, the first focus unit F1 may have negative refractive power and a lens unit that is adjacent to and disposed on the image side of the first focus unit F1 may have positive refractive power.

In order to reduce the lens diameter of the second focus unit F2 and its weight, the second focus unit F2 may have negative refractive power and a lens unit that is adjacent to and disposed on the image side of the second focus unit F2 may have positive refractive power.

Inequality (6) defines a proper relationship between the focal length fF2 of the second focus unit F2 and the focal length fRb of the fixed lens unit BRb disposed between the first focus unit F1 and the second focus unit F2, and illustrates a condition for reducing the lens diameter of the second focus unit F2. In a case where fF2/fRb becomes higher than the upper limit of inequality (6), the focal length of the lens unit BRb increases, and an effect of miniaturizing the zoom lens reduces. In a case where fF2/fRb becomes lower than the lower limit of inequality (6), the focal length of the lens unit BRb decreases, it becomes difficult to secure the required back focus.

Inequality (7) defines a proper relationship between the imaging magnification βF1t of the first focus unit F1 at the telephoto end and the imaging magnification βF2t of the second focus unit F2 at the telephoto end, and illustrates a condition for reducing the size of each focus unit and focus breathing while a sufficient back focus is secured. In a case where βF1t/βF2t becomes higher than the upper limit of inequality (7), the first focus unit F1 and the second focus unit F2 become too close to each other, and it becomes difficult to share the burden of correcting spherical aberration and curvature of field. In a case where βF1t/βF2t becomes lower than the lower limit of inequality (7), the lens diameter of the second focus unit F2 is likely to increase, and it becomes difficult to reduce the weight of the second focus unit F2. Satisfying inequality (7) can place a lens unit between the first focus unit F1 and the second focus unit F2.

Inequality (8) defines a proper relationship between the focus sensitivity besF1t of the first focus unit F1 and the focus sensitivity besF2t of the second focus unit F2, and illustrates a condition for improving focus accuracy and focus breathing. The focus sensitivities are expressed by the following inequalities:

$$besF 1 t = ( 1 - β F 1 {t}^{2} ) \times β F 1 {Rt}^{2}$$

$$besF 2 t = ( 1 - β F 2 {t}^{2} ) \times β F 2 {Rt}^{2}$$

where βF1Rt is a combined imaging magnification of one or more lens units on the image side of the first focus unit F1 at the telephoto end, and βF2Rt is a combined imaging magnification of one or more lens units on the image side of the second focus unit F2 at the telephoto end. Focus sensitivity is a focus change amount on the image plane relative to a unit moving amount of the focus unit.

In a case where |besF1t|/|besF2t| becomes higher than the upper limit of inequality (8), the focus sensitivity of the first focus unit F1 becomes too high. As a result, the focus accuracy is likely to decrease due to an error in the stopping position of the first focus unit F1. In a case where |besF1t|/|besF2t| becomes lower than the lower limit of inequality (8), the focus sensitivity of the second focus unit F2 becomes too high. As a result, it becomes difficult to reduce focus breathing while variations in spherical aberration and field curvature associated with changes in object distance are suppressed.

Inequality (9) defines a proper position of the aperture stop STO (distance ST from the image plane img) relative to the overall lens length TTL, and illustrates a condition for suppressing an angle change of a principal ray in a case where the aperture in the aperture stop STO is narrowed. In a case where ST/TTL becomes higher than the upper limit of inequality (9), the aperture stop STO is located on the image side of the proper position, and a light amount of the lower ray is likely to be insufficient at the telephoto end. In a case where ST/TTL becomes lower than the lower limit of inequality (9), the aperture stop STO is located on the object side of the proper position, and a moving amount of each intermediate lens unit during zooming reduces, and it is to strengthen the refractive power of each intermediate lens unit. As a result, the fluctuations in the curvature of field and spherical aberration associated with zooming are likely to increase.

Inequality (10) defines a proper relationship between the focal length fFt of the front group LF at the telephoto end and the focal length fRt of the rear group LR at the telephoto end, and illustrates a condition for suppressing the outer aperture diameter while the one-sided aperture is improved. In a case where fFt/fRt becomes higher than the upper limit of inequality (10), the outer aperture diameter can be suppressed, but the one-sided aperture is likely to increase at the telephoto end. In a case where fFt/fRt becomes lower than the lower limit of equation (10), the one-sided aperture is improved, but the outer aperture diameter is likely to increase.

By making the focal length of the front group LF negative and the focal length of the rear group LR positive, an on-axis light ray can be divergent at the position of the aperture stop STO, and even if the aperture stop STO is disposed on the object side in the rear group LR, the outer diameter is less likely to increase.

A lens unit closest to the object among the intermediate lens units may include a positive lens and a negative lens arranged from the object side. A lens unit closest to the image plane in the intermediate lens units may include a positive lens and a negative lens arranged from the object side. This lens arrangement can satisfactorily correct chromatic aberration in the intermediate lens units. By using lens units having the positive and negative refractive power arrangement arranged from the object side, the principal point position can be moved toward the image side, and the overall lens length can be reduced.

Inequalities (11) and (12) respectively define proper relationships between the moving amounts mF1w and mF1t of the first focus unit F1 and the moving amounts mF2w and mF2t of the second focus unit F2 during focusing at the wide-angle end and the telephoto end, and illustrate conditions for reducing aberration fluctuations and focus breathing relative to changes in object distance. In a case where |mF2w|/|mF1w| and |mF2t|/|mF1t| become higher than the upper limits of inequalities (11) and (12), respectively, the moving amount of the second focus unit F2 increases, and it becomes difficult to correct spherical aberration. In a case where |mF2w|/|mF1w| and |mF2t|/|mF1t| become lower than the lower limits of inequalities (11) and (12), respectively, the moving amount of the second focus unit F2 decrease, and it becomes difficult to correct focus breathing.

Inequality (13) defines a proper shape factor SF2 of one negative lens constituting the second focus unit F2. SF2 is expressed by the following inequality:

$$SF 2 = ( R 2 + R1 ) / ( R 2 - R 1 )$$

where R1 is a radius of curvature of a surface on the object side of the negative lens, and R2 is a radius of curvature of a surface on the image side of the negative lens.

Since the second focus unit F2 is disposed at a position close to the image plane, it needs to have a shape that reduces ghost light caused by reflections on the imaging surface of the image sensor disposed on the image plane img and the second focus unit F2. In a case where SF2 becomes higher than the upper limit of inequality (13), the degree of meniscus shape of the negative lens increases, and the focus correcting effect of the second focus unit F2 decreases. In a case where SF2 becomes lower than the lower limit of inequality (13), ghost light caused mainly by reflections of a surface on the image side of the negative lens and the imaging surface is easily generated.

Inequality (14) defines a proper range of the refractive index NdF2 of one negative lens as the second focus unit F2. In a case where NdF2 becomes higher than the upper limit of inequality (14), the Petzval sum of the rear group LR deteriorates. In a case where NdF2 becomes lower than the lower limit of inequality (14), the focus correcting effect of the second focus unit F2 decreases.

Inequality (15) defines a proper relationship between the overall lens length TTL and the focal length ft of the entire zoom lens system at the telephoto end. In a case where TTL/ft becomes higher than the upper limit of inequality (15), it becomes difficult to reduce the overall lens length while the lens diameter of the first lens unit B1 is suppressed. In a case where TTL/ft becomes lower than the lower limit of inequality (15), it becomes difficult to place the aperture stop STO at a proper position while the required zoom magnification is secured.

Inequality (16) defines a proper relationship between the focal length fi of the final lens unit Bi and the back focus BF, and illustrates a condition for reducing the size of each focus unit while the insertion of an extender is enabled. In a case where BF/fi becomes lower than the lower limit of inequality (16), the refractive index of the final lens unit Bi is too weak to obtain a convergence effect, and the lens diameter of each focus unit increases. In a case where BF/fi becomes higher than the upper limit of inequality (16), the refractive power of the final lens unit Bi is too strong, and it becomes difficult to secure a sufficient back focus.

In a case where the zoom lens includes an image stabilizing unit that moves in a direction perpendicular to the optical axis to correct image blur, a part of the rear group LR may be used as the image stabilizing unit. In particular, moving a part of the lens unit BRa adjacent to and disposed on the object side of the first focus unit F1 relative to the optical axis can reduce the weight of the image stabilizing unit while good image stabilizing performance is secured.

In the zoom lenses according to Examples 1 to 5, the fifth lens unit from the object side is divided into a sub-lens unit 5a having positive refractive power, a sub-lens unit 5b having positive refractive power, and a sub-lens unit 5c having positive refractive power, and the sub-lens unit 5b is used as the image stabilizing unit. In the zoom lens according to Example 6, the fourth lens unit from the object side is divided into a sub-lens unit 4a having positive refractive power, a sub-lens unit 4b having positive refractive power, and a sub-lens unit 4c having positive refractive power, and the sub-lens unit 4b is used as the image stabilizing unit.

In order to suppress the occurrence of color shift when the image stabilizing unit moves relative to the optical axis, the image stabilizing unit may include at least a positive lens and a negative lens. Furthermore, the image stabilizing unit has an aspheric surface, and thus can suppress changes in coma during image stabilization without increasing the number of lenses.

Inequalities (3) to (16) may be replaced with inequalities (3a) to (16a) below:

$$- 6.0 \leq fFT / fT \leq - 0.4 \qquad ( 3 a )$$

$$- 1.8 \leq fF 1 / fRa \leq - 0.8 \qquad ( 4 a )$$

$$- 1.5 \leq fF 1 / fi \leq - 0.2 \qquad ( 5 a )$$

$$- 1. \leq fF 2 / fRb \leq - 0.4 \qquad ( 6 a )$$

$$0.75 \leq β F 1 t / β F 2 t \leq 2.00 \qquad ( 7 a )$$

$$1.8 \leq \vert besF 1 t \vert / \vert besF 2 t \vert \leq 4. \qquad ( 8 a )$$

$$0.45 \leq ST / TTL \leq 0.65 \qquad ( 9 a )$$

$$- 20. 0 \leq fFt / fRt \leq - 1.5 \qquad ( 10 a )$$

$$0.6 \leq \vert m F 2 w \vert / \vert m F 1 w \vert \leq 1.6 \qquad ( 11 a )$$

$$0.4 \leq \vert m F 2 t \vert / \vert m F 1 t \vert \leq 1.5 \qquad ( 12 a )$$

$$0.5 \leq SF 2 \leq 1.5 \qquad ( 13 a )$$

$$1.7 \leq Nd F 2 \leq 1.9 \qquad ( 14 a )$$

$$0.6 \leq TTL / fT \leq 1.4 \qquad ( 15 a )$$

$$0.25 \leq BF / fi \leq 0. 50 \qquad ( 16 a )$$

Inequalities (3) to (16) may be replaced with inequalities (3b) to (16b) below:

$$- 5.5 \leq fFT / fT \leq - 0.8 \qquad ( 3 b )$$

$$- 1.5 \leq fF 1 / fRa \leq - 1. \qquad ( 4 b )$$

$$- 1. \leq fF 1 / fi \leq - 0.4 \qquad ( 5 b )$$

$$- 0.8 \leq fF 2 / fRb \leq - 0.4 \qquad ( 6 b )$$

$$0.8 \leq β F 1 t / β F 2 t \leq 1.5 \qquad ( 7 b )$$

$$2. \leq \vert besF 1 t \vert / \vert besF 2 t \vert \leq 3. \qquad ( 8 b )$$

$$0.48 \leq ST / TTL \leq 0.60 \qquad ( 9 b )$$

$$- 15. \leq fFt / fRt \leq - 2.5 \qquad ( 10 b )$$

$$0.5 \leq \vert m F 2 w \vert / \vert m F 1 w \vert \leq 1.8 \qquad ( 11 b )$$

$$0.35 \leq \vert m F 2 t \vert / \vert m F 1 t \vert \leq 1.2 \qquad ( 12 b )$$

$$0.8 \leq SF 2 \leq 1.2 \qquad ( 13 b )$$

$$1.75 \leq N d F 2 \leq 1.8 \qquad ( 14 b )$$

$$0.7 \leq TTL / fT \leq 1.35 \qquad ( 15 b )$$

$$0.3 \leq BF / fi \leq 0.4 \qquad ( 16 b )$$

A lens unit with almost no substantial refractive power may be disposed on the object side and the image side of the zoom lens according to each example.

A description will now be given of zoom lenses according to numerical examples 1 to 6 corresponding to Examples 1 to 6. In the surface data, a surface number i indicates the order of the surface when counted from the object side. r represents a radius of curvature of an i-th surface counted from the object side (mm), d represents a lens thickness or air gap between i-th and (i+1)-th surfaces (mm), and nd represents a refractive index for the d-line of the optical material. vd represents an Abbe number based on the d-line of the optical material between the i-th surface and the (i+1)-th surface. The Abbe number based on the d-line is expressed as:

$$ν d = ( Nd - 1 ) / ( NF - NC )$$

where Nd, NF, and NC are refractive indices for the d-line (587.6 nm), F-line (486.1 nm), and C-line (656.3 nm) in the Fraunhofer line, respectively.

The effective diameter is a radius (mm) of an area of the i-th lens surface through which light rays that contribute to imaging pass.

In various data, the focal length and F-number are values in an in-focus state on an object at infinity. The image height indicates a real image height. BF represents a back focus (mm). As described above, the back focus is a distance on the optical axis from a final surface (a surface closest to the image plane) of the zoom lens to the paraxial image plane, expressed in air equivalent length. The overall lens length is a distance on the optical axis from the frontmost surface (a surface closest to the object) to the final surface plus the back focus. EnPP represents an entrance pupil position, ExPP represents an exit pupil position, FPPP represents a front principal-point position, and RPPP represents a rear principal-point position.

In lens unit data, LP represents a lens unit, SS represents a starting surface, FL represents a focal length, LCL represents a lens configuration length, FPPP represents a front principal-point position, and RPPP represents a rear principal-point position.

An asterisk “*” next to a surface number indicates that the surface has an aspheric shape. The aspheric shape is expressed by the following equation:

$$x = ( {y}^{2} / R ) / [ 1 + {\{ 1 - ( 1 + K ) ( {y}^{2} / {R}^{2} ) \}}^{1 / 2} ] + A 4 {y}^{4} + A 6 {y}^{6} + A 8 {y}^{8} + A 10 {y}^{10} + A 12 {y}^{12}$$

where x is a displacement amount from a surface vertex in the optical axis direction, y is a height from the optical axis in a direction perpendicular to the optical axis, a light traveling direction is set positive, R is a paraxial radius of curvature, K is a conic constant, and A4, A6, A8, A10, and A12 are aspheric coefficients.

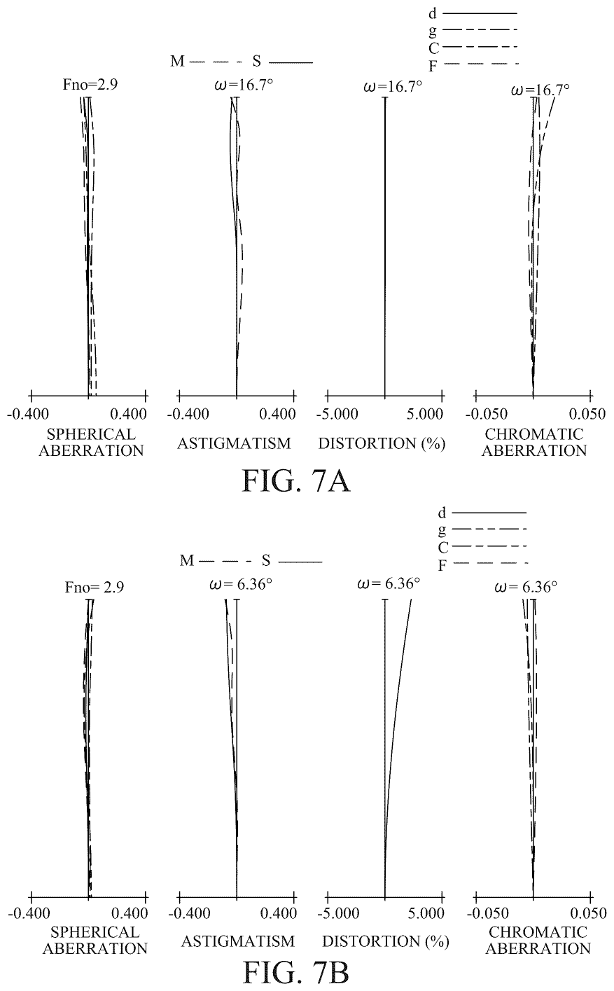

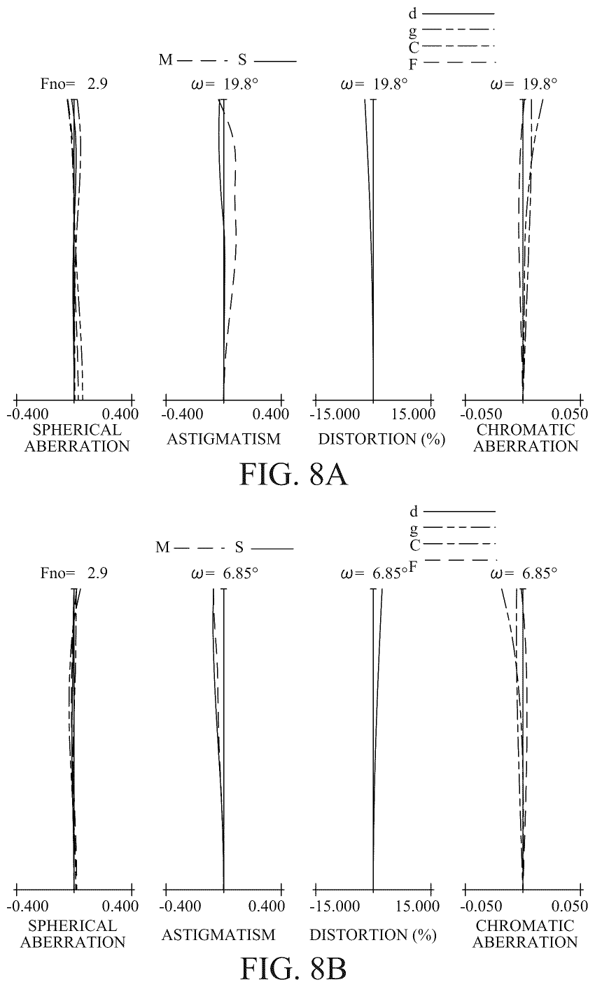

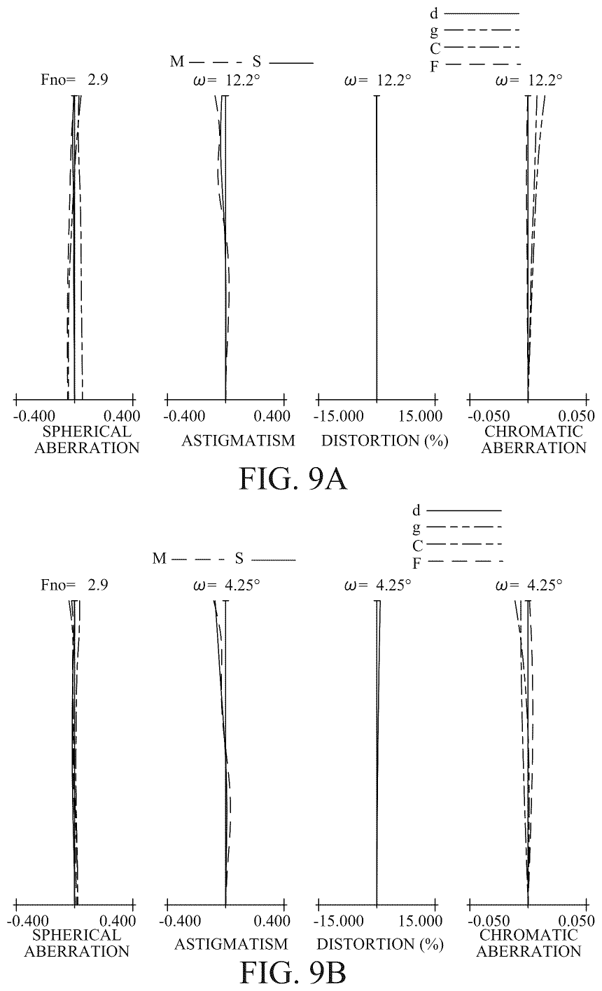

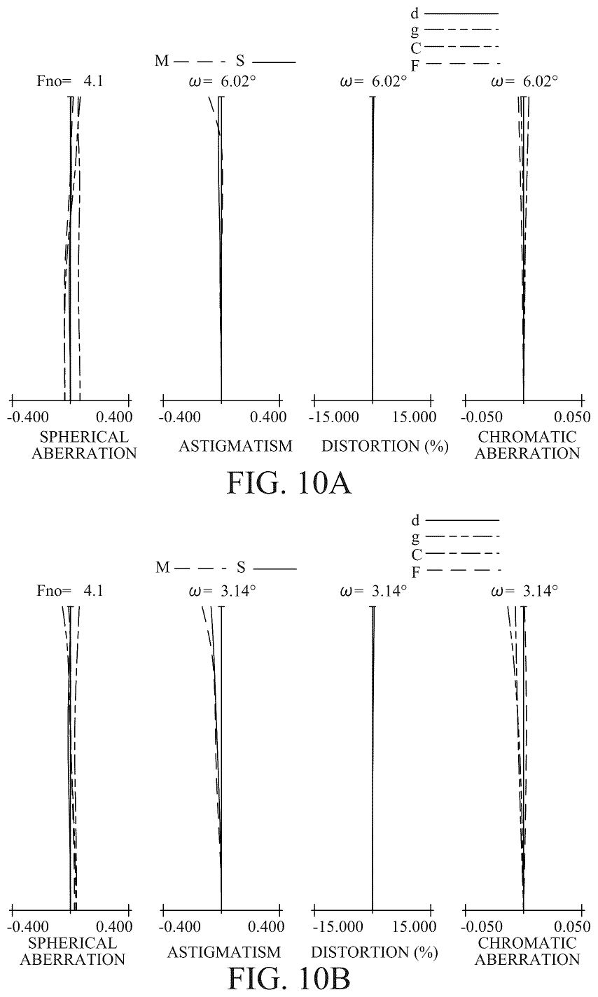

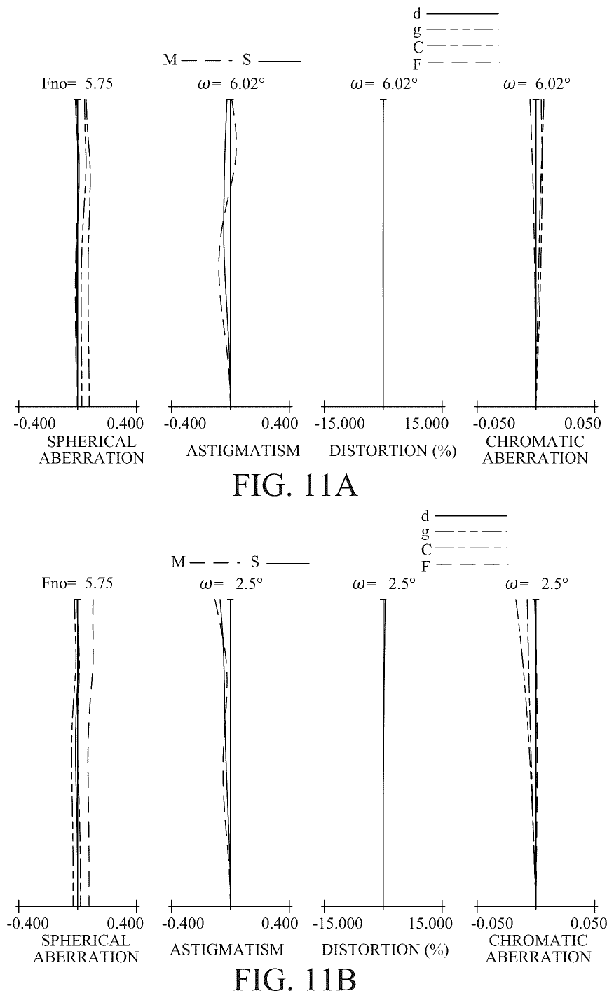

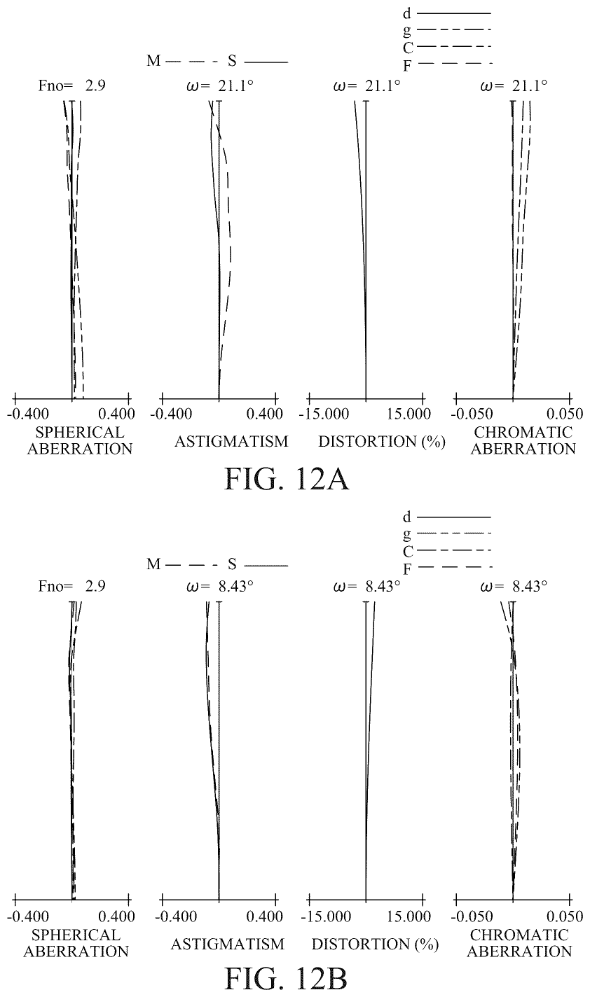

FIGS. 7A, 8A, 9A, 10A, 11A, and 12A illustrate longitudinal aberrations (spherical aberration, astigmatism, distortion, and chromatic aberration) at a wide-angle end of the zoom lenses according to numerical examples 1 to 6, and FIGS. 7B, 8B, 9B, 10B, 11B, and 12B illustrate longitudinal aberrations (spherical aberration, astigmatism, distortion, and chromatic aberration) a telephoto end of the zoom lenses according to numerical examples 1 to 6. In the spherical aberration diagram, Fno represents an F-number, a solid line indicates a spherical aberration amount for the d-line (wavelength 587.6 nm), a dashed line indicates a spherical aberration amount for the F-line (wavelength 486.13 nm), an alternate long and short dash line indicates a spherical aberration amount for the C-line (wavelength 656.27 nm), and an alternate long and two short dashes line indicates a spherical aberration amount for the g-line (wavelength 435.83 nm). A scale on the horizontal axis indicates a defocus amount, which ranges from −0.4 to +0.4 [mm]. In the astigmatism diagram, a solid line S indicates an astigmatism amount on a sagittal image plane, and a broken line M indicates an astigmatism amount on a meridional image plane. The horizontal axis is the same as that of the spherical aberration. The distortion diagram is a distortion amount for the d-line. A scale on the horizontal axis ranges from −15 to +15%. The chromatic aberration diagram illustrates lateral chromatic aberration amounts for the F-line, C-line, and g-line. A scale on the horizontal axis is a defocus amount, which ranges from −0.05 to +0.05 mm. ω is a half angle of view (°).

### Numerical Example 1

UNIT: mm
SURFACE DATA

| Surface | | | | | Effective |
|---|---|---|---|---|---|
| No. | r | d | nd | νd | Diameter |
| 1 | 118.641 | 1.45 | 1.74951 | 35.3 | 67.72 |
| 2 | 75.807 | 10.58 | 1.43875 | 94.7 | 66.17 |
| 3 | −665.627 | 0.20 | | | 65.63 |
| 4 | 74.187 | 7.71 | 1.43875 | 94.7 | 64.07 |
| 5 | 280.505 | (Variable) | | | 63.15 |
| 6 | 71.420 | 5.82 | 1.56732 | 42.8 | 46.31 |
| 7 | −798.337 | 0.20 | | | 44.70 |
| 8 | 233.290 | 1.40 | 1.65160 | 58.5 | 41.82 |
| 9 | 38.096 | (Variable) | | | 36.43 |
| 10 | −74.807 | 1.40 | 1.53775 | 74.7 | 34.56 |
| 11 | 61.389 | (Variable) | | | 33.04 |
| 12 | 52.538 | 3.55 | 1.85478 | 24.8 | 33.57 |
| 13 | 149.814 | 3.46 | | | 33.25 |
| 14 | −62.946 | 1.40 | 1.59349 | 67.0 | 33.21 |
| 15 | 283.696 | (Variable) | | | 33.65 |
| 16 (SP) | ∞ | 0.40 | | | 34.39 |
| 17* | 31.136 | 10.95 | 1.49700 | 81.5 | 35.88 |
| 18* | −70.106 | 0.20 | | | 35.11 |
| 19 | 321.201 | 1.40 | 1.77047 | 29.7 | 33.74 |
| 20 | 35.344 | 4.34 | | | 32.10 |
| 21 | 69.827 | 1.05 | 1.85478 | 24.8 | 32.51 |
| 22 | 36.387 | 6.37 | 1.80400 | 46.5 | 32.14 |
| 23 | −336.651 | 0.07 | 1.58946 | 30.6 | 31.90 |
| 24* | −302.040 | 3.01 | | | 31.89 |
| 25 | 44.773 | 5.10 | 1.59522 | 67.7 | 30.31 |
| 26 | −541.557 | (Variable) | | | 29.34 |
| 27 | 795.915 | 2.78 | 1.92286 | 20.9 | 27.23 |
| 28 | −86.227 | 1.10 | 1.62299 | 58.2 | 26.99 |
| 29 | 26.939 | (Variable) | | | 25.80 |
| 30* | −154.619 | 4.65 | 1.58313 | 59.4 | 30.94 |
| 31* | −41.311 | (Variable) | | | 31.40 |
| 32 | −48.413 | 1.30 | 1.77047 | 29.7 | 31.25 |
| 33 | ∞ | (Variable) | | | 32.25 |
| 34 | 126.157 | 3.10 | 2.00100 | 29.1 | 38.91 |
| 35 | −1961.022 | (Variable) | | | 39.01 |
| Image Plane | ∞ | | | | |

ASPHERIC DATA
17th Surface
K = 0.00000e+00 A 4 = −4.11423e−06 A 6 = −4.02996e−10
A 8 = −4.42991e−12 A10 = 5.14141e−16
18th Surface
K = 0.00000e+00 A 4 = 3.38559e−06 A 6 = −7.98271e−10
A 8 = −3.40353e−12 A10 = 4.45865e−15
24th Surface
K = 0.00000e+00 A 4 = 5.60156e−07 A 6 = 5.19683e−10
A 8 = −2.15534e−13 A10 = −1.04557e−15
30th Surface
K = 0.00000e+00 A 4 = 7.95991e−06 A 6 = −1.42359e−08 A 8 =
1.09768e−10 A10 = −4.12759e−13 A12 = 5.90882e−16
31st Surface
K = 0.00000e+00 A 4 = 6.06354e−06 A 6 = −1.52294e−08 A 8 =
1.08850e−10 A10 = −4.00403e−13 A12 = 5.48878e−16

VARIOUS DATA
ZOOM RATIO 2.69

| | WIDE | MIDDLE | TELE |
|---|---|---|---|
| Focal Length | 72.00 | 120.07 | 194.00 |
| Fno | 2.90 | 2.90 | 2.90 |
| Half Angle of View (°) | 16.72 | 10.21 | 6.36 |
| Image Height | 21.64 | 21.64 | 21.64 |
| Overall Lens Length | 217.10 | 217.10 | 217.10 |
| BF | 37.13 | 37.13 | 37.13 |
| d5 | 1.48 | 24.67 | 42.97 |
| d9 | 8.46 | 10.54 | 13.14 |
| d11 | 20.31 | 8.04 | 1.81 |
| d15 | 31.22 | 18.22 | 3.55 |
| d26 | 1.88 | 2.65 | 1.54 |
| d29 | 18.60 | 17.83 | 18.94 |
| d31 | 5.56 | 6.75 | 2.28 |
| d33 | 9.48 | 8.29 | 12.76 |
| d35 | 37.13 | 37.13 | 37.13 |
| EnPP | 87.99 | 147.59 | 199.11 |
| ExPP | −80.55 | −77.00 | −88.84 |
| FPPP | 115.94 | 141.34 | 94.34 |
| RPPP | −34.87 | −82.94 | −156.87 |

LENS UNIT DATA

| LU | SS | FL | LCL | FPPP | RPPP |
|---|---|---|---|---|---|
| 1 | 1 | 138.69 | 19.94 | 4.25 | −9.53 |
| 2 | 6 | −197.36 | 7.42 | 13.35 | 8.06 |
| 3 | 10 | −62.48 | 1.40 | 0.50 | −0.41 |
| 4 | 12 | 86681.55 | 8.41 | −6517.96 | −6068.02 |
| 5 | 16 | 37.05 | 32.89 | 13.85 | −13.35 |
| 6 | 27 | −54.40 | 3.88 | 2.39 | 0.26 |
| 7 | 30 | 95.23 | 4.65 | 3.95 | 1.05 |
| 8 | 32 | −62.84 | 1.30 | −0.00 | −0.73 |
| 9 | 34 | 118.50 | 3.10 | 0.09 | −1.46 |

SINGLE LENS DATA

| Lens | Starting Surface | Focal Length |
|---|---|---|
| 1 | 1 | −284.27 |
| 2 | 2 | 155.79 |
| 3 | 4 | 227.30 |
| 4 | 6 | 115.83 |
| 5 | 8 | −70.07 |
| 6 | 10 | −62.48 |
| 7 | 12 | 93.09 |
| 8 | 14 | −86.67 |
| 9 | 17 | 45.00 |
| 10 | 19 | −51.66 |
| 11 | 21 | −90.20 |
| 12 | 22 | 41.16 |
| 13 | 23 | 4980.24 |
| 14 | 25 | 69.70 |
| 15 | 27 | 84.43 |
| 16 | 28 | −32.83 |
| 17 | 30 | 95.23 |
| 18 | 32 | −62.84 |
| 19 | 34 | 118.50 |

### Numerical Example 2

UNIT: mm
SURFACE DATA

| Surface | | | | | Effective |
|---|---|---|---|---|---|
| No. | r | d | nd | νd | Diameter |
| 1 | 114.373 | 1.40 | 1.90366 | 31.3 | 65.03 |
| 2 | 83.254 | 9.20 | 1.43875 | 94.7 | 63.81 |
| 3 | −687.171 | 0.20 | | | 63.24 |
| 4 | 72.870 | 7.55 | 1.43875 | 94.7 | 60.01 |
| 5 | 372.512 | (Variable) | | | 58.77 |
| 6 | 188.724 | 3.60 | 1.72047 | 34.7 | 41.43 |
| 7 | −294.244 | 0.20 | | | 40.01 |
| 8 | 774.429 | 1.40 | 1.72916 | 54.7 | 37.87 |
| 9 | 36.916 | (Variable) | | | 33.22 |
| 10 | −56.442 | 1.40 | 1.53775 | 74.7 | 31.54 |
| 11 | 154.766 | (Variable) | | | 31.97 |
| 12 | 67.137 | 3.90 | 1.85478 | 24.8 | 32.88 |
| 13 | −294.768 | 2.25 | | | 32.80 |
| 14 | −54.934 | 1.40 | 1.61340 | 44.3 | 32.76 |
| 15 | 213.549 | (Variable) | | | 33.28 |
| 16 (SP) | ∞ | 2.10 | | | 33.98 |
| 17* | 29.294 | 10.00 | 1.49700 | 81.5 | 36.33 |
| 18* | −74.795 | 1.58 | | | 35.80 |
| 19 | 132.142 | 1.40 | 1.77047 | 29.7 | 33.37 |
| 20 | 31.454 | 4.85 | | | 31.48 |
| 21 | 71.942 | 1.05 | 1.85478 | 24.8 | 31.81 |
| 22 | 36.789 | 6.00 | 1.80400 | 46.5 | 31.43 |
| 23 | −473.050 | 0.07 | 1.58946 | 30.6 | 31.18 |
| 24* | −424.100 | 1.95 | | | 31.17 |
| 25 | 42.310 | 4.75 | 1.59522 | 67.7 | 29.91 |
| 26 | −1172.836 | (Variable) | | | 29.07 |
| 27 | 233.568 | 2.80 | 1.92286 | 20.9 | 26.49 |
| 28 | −97.675 | 1.10 | 1.70300 | 52.4 | 25.97 |
| 29 | 28.249 | (Variable) | | | 24.95 |
| 30* | −88.284 | 4.50 | 1.58313 | 59.4 | 29.99 |
| 31* | −33.732 | (Variable) | | | 30.39 |
| 32 | −45.317 | 1.30 | 1.77047 | 29.7 | 30.30 |
| 33 | ∞ | (Variable) | | | 31.42 |
| 34 | 75.461 | 3.10 | 2.00100 | 29.1 | 38.00 |
| 35 | 212.837 | (Variable) | | | 37.97 |
| Image Plane | ∞ | | | | |

ASPHERIC DATA
17th Surface
K = 0.00000e+00 A 4 = −4.73081e−06 A 6 = −9.47473e−10
A 8 = −3.88020e−12 A10 = −3.54263e−15
18th Surface
K = 0.00000e+00 A 4 = 3.21449e−06 A 6 = −4.15483e−11
A 8 = −4.31937e−12 A10 = 4.21989e−15
24th Surface
K = 0.00000e+00 A 4 = 4.20899e−07 A 6 = 3.18000e−10 A 8 =
5.69604e−13 A10 = −2.62648e−15
30th Surface
K = 0.00000e+00 A 4 = 1.07860e−05 A 6 = −1.03082e−08 A 8 =
1.31462e−10 A10 = −3.35533e−13 A12 = 6.90525e−16
31st Surface
K = 0.00000e+00 A 4 = 1.01449e−05 A 6 = −6.86964e−09 A 8 =
1.02439e−10 A10 = −2.54359e−13 A12 = 6.58551e−16

VARIOUS DATA
ZOOM RATIO 3.00

| | WIDE | MIDDLE | TELE |
|---|---|---|---|
| Focal Length | 60.00 | 119.96 | 180.00 |
| Fno | 2.90 | 2.90 | 2.90 |
| Half Angle of View (°) | 19.83 | 10.22 | 6.85 |
| Image Height | 21.64 | 21.64 | 21.64 |
| Overall Lens Length | 210.00 | 210.00 | 210.00 |
| BF | 37.12 | 37.12 | 37.12 |
| d5 | 1.52 | 31.86 | 47.37 |
| d9 | 8.20 | 9.28 | 8.47 |
| d11 | 13.80 | 3.81 | 1.48 |
| d15 | 36.95 | 15.51 | 3.15 |
| d26 | 1.50 | 3.49 | 2.61 |
| d29 | 19.16 | 17.17 | 18.05 |
| d31 | 3.32 | 5.78 | 2.49 |
| d33 | 9.38 | 6.93 | 10.22 |
| d35 | 37.12 | 37.12 | 37.12 |
| EnPP | 67.95 | 141.27 | 182.71 |
| ExPP | −79.66 | −71.84 | −80.38 |
| FPPP | 97.13 | 129.15 | 86.98 |
| RPPP | −22.88 | −82.84 | −142.88 |

LENS UNIT DATA

| LU | SS | FL | LCL | FPPP | RPPP |
|---|---|---|---|---|---|
| 1 | 1 | 128.72 | 18.35 | 3.89 | −8.75 |
| 2 | 6 | −81.46 | 5.20 | 4.39 | 1.23 |
| 3 | 10 | −76.73 | 1.40 | 0.24 | −0.67 |
| 4 | 12 | 417.63 | 7.55 | −23.95 | −27.61 |
| 5 | 16 | 36.64 | 33.75 | 14.95 | −14.10 |
| 6 | 27 | −54.19 | 3.90 | 2.65 | 0.53 |
| 7 | 30 | 90.86 | 4.50 | 4.46 | 1.71 |
| 8 | 32 | −58.82 | 1.30 | −0.00 | −0.73 |
| 9 | 34 | 115.49 | 3.10 | −0.84 | −2.37 |

SINGLE LENS DATA

| Lens | Starting Surface | Focal Length |
|---|---|---|
| 1 | 1 | −345.99 |
| 2 | 2 | 169.87 |
| 3 | 4 | 204.90 |
| 4 | 6 | 160.09 |
| 5 | 8 | −53.20 |
| 6 | 10 | −76.73 |
| 7 | 12 | 64.29 |
| 8 | 14 | −71.09 |
| 9 | 17 | 43.75 |
| 10 | 19 | −53.90 |
| 11 | 21 | −89.31 |
| 12 | 22 | 42.68 |
| 13 | 23 | 6949.10 |
| 14 | 25 | 68.71 |
| 15 | 27 | 74.93 |
| 16 | 28 | −31.06 |
| 17 | 30 | 90.86 |
| 18 | 32 | −58.82 |
| 19 | 34 | 115.49 |

### Numerical Example 3

UNIT: mm
SURFACE DATA

| Surface | | | | | Effective |
|---|---|---|---|---|---|
| No. | r | d | nd | νd | Diameter |
| 1 | 172.753 | 2.10 | 1.89190 | 37.1 | 100.34 |
| 2 | 110.864 | 16.40 | 1.43875 | 94.7 | 98.59 |
| 3 | −669.069 | 0.30 | | | 98.38 |
| 4 | 110.587 | 11.20 | 1.43875 | 94.7 | 96.23 |
| 5 | 431.001 | (Variable) | | | 95.11 |
| 6 | 192.334 | 6.30 | 1.74951 | 35.3 | 63.66 |
| 7 | −467.535 | 0.30 | | | 62.57 |
| 8 | −1438.668 | 2.10 | 1.51742 | 52.4 | 61.66 |
| 9 | 68.833 | (Variable) | | | 56.97 |
| 10 | −108.485 | 2.10 | 1.53775 | 74.7 | 45.95 |
| 11 | 115.605 | (Variable) | | | 45.41 |
| 12 | 70.118 | 5.40 | 1.85478 | 24.8 | 45.69 |
| 13 | 243.257 | 2.53 | | | 45.00 |
| 14 | −191.736 | 2.10 | 1.61340 | 44.3 | 44.95 |
| 15 | 104.468 | (Variable) | | | 44.30 |
| 16 (SP) | ∞ | 0.40 | | | 44.52 |
| 17* | 48.817 | 10.20 | 1.49700 | 81.5 | 45.00 |
| 18* | −135.473 | 9.25 | | | 44.21 |
| 19 | 4215.717 | 2.10 | 1.77047 | 29.7 | 38.90 |
| 20 | 48.855 | 11.75 | | | 37.44 |
| 21 | 85.709 | 1.57 | 1.85478 | 24.8 | 39.40 |
| 22 | 44.786 | 8.70 | 1.80400 | 46.5 | 38.96 |
| 23 | −304.217 | 0.10 | 1.58946 | 30.6 | 38.62 |
| 24* | −265.675 | 1.00 | | | 38.61 |
| 25 | 55.204 | 5.00 | 1.59522 | 67.7 | 37.29 |
| 26 | 400.814 | (Variable) | | | 36.35 |
| 27 | 1772.602 | 4.20 | 1.92286 | 20.9 | 32.88 |
| 28 | −101.531 | 1.65 | 1.70300 | 52.4 | 32.47 |
| 29 | 37.887 | (Variable) | | | 31.18 |
| 30* | −1039.603 | 5.90 | 1.58313 | 59.4 | 38.59 |
| 31* | −52.894 | (Variable) | | | 38.77 |
| 32 | −56.554 | 1.95 | 1.77047 | 29.7 | 37.42 |
| 33 | ∞ | (Variable) | | | 38.45 |
| 34 | 87.148 | 4.20 | 2.00100 | 29.1 | 45.44 |
| 35 | 322.866 | (Variable) | | | 45.25 |
| Image Plane | ∞ | | | | |

ASPHERIC DATA
17th Surface
K = 0.00000e+00 A 4 = −8.52024e−07 A 6 = −4.15328e−10 A 8 =
9.29658e−14 A10 = −5.44870e−16
18th Surface
K = 0.00000e+00 A 4 = 4.68123e−07 A 6 = −3.73033e−10 A 8 =
8.15517e−14 A10 = −2.75722e−16
24th Surface
K = 0.00000e+00 A 4 = 3.55470e−07 A 6 = 1.31857e−10
A 8 = −1.95555e−14 A10 = −2.25525e−16
30th Surface
K = 0.00000e+00 A 4 = 2.11329e−06 A 6 = 2.02480e−10 A 8 =
1.84288e−11 A10 = −5.61258e−14 A12 = 9.40795e−17
31st Surface
K = 0.00000e+00 A 4 = 1.34443e−06 A 6 = −2.32714e−09 A 8 =
2.98680e−11 A10 = −8.65384e−14 A12 = 1.25435e−16

VARIOUS DATA
ZOOM RATIO 2.91

| | WIDE | MIDDLE | TELE |
|---|---|---|---|
| Focal Length | 100.00 | 185.26 | 291.00 |
| Fno | 2.90 | 2.88 | 2.90 |
| Half Angle of View (°) | 12.21 | 6.66 | 4.25 |
| Image Height | 21.64 | 21.64 | 21.64 |
| Overall Lens Length | 320.20 | 320.20 | 320.20 |
| BF | 37.14 | 37.14 | 37.14 |
| d5 | 1.48 | 42.15 | 65.62 |
| d9 | 21.10 | 30.28 | 38.63 |
| d11 | 41.33 | 11.62 | 1.49 |
| d15 | 46.71 | 26.58 | 4.88 |
| d26 | 8.96 | 7.41 | 1.76 |
| d29 | 21.03 | 22.59 | 28.23 |
| d31 | 14.97 | 14.31 | 7.17 |
| d33 | 8.67 | 9.33 | 16.46 |
| d35 | 37.14 | 37.14 | 37.14 |
| EnPP | 152.02 | 281.50 | 363.03 |
| ExPP | −134.29 | −140.79 | −195.97 |
| FPPP | 193.69 | 273.88 | 290.77 |
| RPPP | −62.86 | −148.11 | −253.86 |

LENS UNIT DATA

| LU | SS | FL | LCL | FPPP | RPPP |
|---|---|---|---|---|---|
| 1 | 1 | 213.61 | 30.00 | 7.29 | −13.38 |
| 2 | 6 | −449.97 | 8.70 | 15.88 | 10.24 |
| 3 | 10 | −103.73 | 2.10 | 0.66 | −0.70 |
| 4 | 12 | 3347.99 | 10.03 | −226.57 | −218.59 |
| 5 | 16 | 58.80 | 50.08 | 29.60 | −20.05 |
| 6 | 27 | −63.28 | 5.85 | 3.40 | 0.24 |
| 7 | 30 | 95.36 | 5.90 | 3.92 | 0.20 |
| 8 | 32 | −73.40 | 1.95 | −0.00 | −1.10 |
| 9 | 34 | 118.19 | 4.20 | −0.77 | −2.85 |

SINGLE LENS DATA

| Lens | Starting Surface | Focal Length |
|---|---|---|
| 1 | 1 | −352.60 |
| 2 | 2 | 218.16 |
| 3 | 4 | 335.47 |
| 4 | 6 | 182.57 |
| 5 | 8 | −126.90 |
| 6 | 10 | −103.73 |
| 7 | 12 | 113.62 |
| 8 | 14 | −109.95 |
| 9 | 17 | 73.56 |
| 10 | 19 | −64.17 |
| 11 | 21 | −111.72 |
| 12 | 22 | 49.10 |
| 13 | 23 | 3553.87 |
| 14 | 25 | 106.98 |
| 15 | 27 | 104.17 |
| 16 | 28 | −39.06 |
| 17 | 30 | 95.36 |
| 18 | 32 | −73.40 |
| 19 | 34 | 118.19 |

### Numerical Example 4

UNIT: mm
SURFACE DATA

| Surface | | | | | Effective |
|---|---|---|---|---|---|
| No. | r | d | nd | νd | Diameter |
| 1 | 184.967 | 2.30 | 1.89190 | 37.1 | 96.34 |
| 2 | 114.981 | 14.00 | 1.43875 | 94.7 | 94.79 |
| 3 | −1238.511 | 0.20 | | | 94.64 |
| 4 | 107.157 | 11.50 | 1.43875 | 94.7 | 93.34 |
| 5 | 538.899 | (Variable) | | | 92.34 |
| 6 | 545.415 | 3.20 | 1.72047 | 34.7 | 68.49 |
| 7 | −1145.045 | 16.60 | | | 67.99 |
| 8 | 250.430 | 3.00 | 1.77250 | 49.6 | 56.80 |
| 9 | 116.759 | (Variable) | | | 54.79 |
| 10 | −107.629 | 2.00 | 1.53775 | 74.7 | 43.62 |
| 11 | 110.642 | (Variable) | | | 42.97 |
| 12 | 74.737 | 5.50 | 1.85478 | 24.8 | 43.11 |
| 13 | 1551.268 | 1.28 | | | 42.51 |
| 14 | −215.491 | 2.00 | 1.80400 | 46.6 | 42.47 |
| 15 | 104.892 | (Variable) | | | 41.71 |
| 16 (SP) | ∞ | 0.40 | | | 41.86 |
| 17* | 98.698 | 7.50 | 1.43875 | 94.7 | 42.00 |
| 18* | −83.153 | 12.41 | | | 41.81 |
| 19 | −1305.936 | 2.00 | 1.77047 | 29.7 | 37.91 |
| 20 | 63.691 | 10.60 | | | 37.31 |
| 21 | 94.885 | 1.80 | 1.85478 | 24.8 | 39.94 |
| 22 | 47.782 | 8.68 | 1.80400 | 46.5 | 39.71 |
| 23 | −274.151 | 0.07 | 1.58946 | 30.6 | 39.58 |
| 24* | −257.021 | 3.00 | | | 39.58 |
| 25 | 76.973 | 5.20 | 1.49700 | 81.5 | 38.50 |
| 26 | −228.030 | (Variable) | | | 37.94 |
| 27 | −415.039 | 3.60 | 1.92286 | 20.9 | 32.70 |
| 28 | −102.980 | 1.50 | 1.59522 | 67.7 | 32.00 |
| 29 | 48.936 | (Variable) | | | 30.02 |
| 30* | −119.435 | 4.00 | 1.58313 | 59.4 | 33.40 |
| 31* | −46.042 | (Variable) | | | 33.67 |
| 32 | −53.950 | 2.00 | 1.77047 | 29.7 | 32.03 |
| 33 | ∞ | (Variable) | | | 32.79 |
| 34 | 95.445 | 3.50 | 2.00069 | 25.5 | 45.27 |
| 35 | 305.293 | (Variable) | | | 45.11 |
| Image Plane | ∞ | | | | |

ASPHERIC DATA
17th Surface
K = 0.00000e+00 A 4 = −8.11761e−07 A 6 = −3.11349e−10
A 8 = −5.54235e−13 A10 = 9.06329e−16
18th Surface
K = 0.00000e+00 A 4 = 2.46153e−08 A 6 = −5.32016e−10
A 8 = −1.22159e−13 A10 = 6.27543e−16
24th Surface
K = 0.00000e+00 A 4 = 2.66397e−07 A 6 = 2.59983e−10
A 8 = −5.24974e−13 A10 = 3.52651e−16
30th Surface
K = 0.00000e+00 A 4 = 1.42270e−06 A 6 = 4.66364e−09 A 8 =
1.24821e−12 A10 = −3.80692e−14 A12 = 9.18092e−17
31st Surface
K = 0.00000e+00 A 4 = 1.21595e−06 A 6 = 4.54091e−09 A 8 =
8.58489e−13 A10 = −3.23705e−14 A12 = 8.09394e−17

VARIOUS DATA
ZOOM RATIO 1.93

| | WIDE | MIDDLE | TELE |
|---|---|---|---|
| Focal Length | 205.00 | 300.19 | 395.00 |
| Fno | 4.10 | 4.07 | 4.10 |
| Half Angle of View (°) | 6.02 | 4.12 | 3.14 |
| Image Height | 21.64 | 21.64 | 21.64 |
| Overall Lens Length | 350.00 | 350.00 | 350.00 |
| BF | 43.54 | 43.54 | 43.54 |
| d5 | 5.03 | 32.32 | 54.04 |
| d9 | 34.32 | 35.97 | 33.79 |
| d1 | 24.73 | 7.01 | 1.50 |
| d15 | 29.84 | 18.62 | 4.59 |
| d26 | 13.37 | 8.40 | 1.49 |
| d29 | 24.44 | 29.40 | 36.32 |
| d31 | 18.52 | 15.48 | 8.80 |
| d33 | 28.38 | 31.42 | 38.10 |
| d35 | 43.54 | 43.54 | 43.54 |
| EnPP | 232.87 | 311.22 | 350.47 |
| ExPP | −199.79 | −228.05 | −298.41 |
| FPPP | 265.16 | 279.60 | 289.19 |
| RPPP | −161.46 | −256.65 | −351.46 |

LENS UNIT DATA

| LU | SS | FL | LCL | FPPP | RPPP |
|---|---|---|---|---|---|
| 1 | 1 | 221.30 | 28.00 | 6.55 | −12.65 |
| 2 | 6 | −711.84 | 22.80 | 53.03 | 30.71 |
| 3 | 10 | −101.13 | 2.00 | 0.64 | −0.66 |
| 4 | 12 | 8523.32 | 8.78 | −500.49 | −477.81 |
| 5 | 16 | 66.50 | 51.65 | 33.51 | −16.32 |
| 6 | 27 | −89.03 | 5.10 | 2.51 | −0.29 |
| 7 | 30 | 125.96 | 4.00 | 4.03 | 1.55 |
| 8 | 32 | −70.02 | 2.00 | −0.00 | −1.13 |
| 9 | 34 | 137.61 | 3.50 | −0.79 | −2.52 |

SINGLE LENS DATA

| Lens | Starting Surface | Focal Length |
|---|---|---|
| 1 | 1 | −346.08 |
| 2 | 2 | 240.56 |
| 3 | 4 | 302.39 |
| 4 | 6 | 513.19 |
| 5 | 8 | −285.96 |
| 6 | 10 | −101.13 |
| 7 | 12 | 91.70 |
| 8 | 14 | −87.51 |
| 9 | 17 | 104.17 |
| 10 | 19 | −78.77 |
| 11 | 21 | −114.63 |
| 12 | 22 | 51.23 |
| 13 | 23 | 6967.51 |
| 14 | 25 | 116.45 |
| 15 | 27 | 147.59 |
| 16 | 28 | −55.53 |
| 17 | 30 | 125.96 |
| 18 | 32 | −70.02 |
| 19 | 34 | 137.61 |

### Numerical Example 5

UNIT: mm
SURFACE DATA

| Surface | | | | | Effective |
|---|---|---|---|---|---|
| No. | r | d | nd | νd | Diameter |
| 1 | 220.924 | 2.30 | 1.89190 | 37.1 | 86.09 |
| 2 | 122.179 | 11.90 | 1.43875 | 94.7 | 85.02 |
| 3 | −604.088 | 0.20 | | | 84.98 |
| 4 | 104.403 | 10.70 | 1.43875 | 94.7 | 84.11 |
| 5 | 846.907 | (Variable) | | | 83.19 |
| 6 | 463.042 | 3.20 | 1.86966 | 20.0 | 54.82 |
| 7 | −1680.439 | 10.93 | | | 54.22 |
| 8 | 311.700 | 2.50 | 1.96300 | 24.1 | 47.43 |
| 9 | 148.755 | (Variable) | | | 46.21 |
| 10 | −180.458 | 2.00 | 1.53775 | 74.7 | 39.96 |
| 11 | 84.993 | (Variable) | | | 39.01 |
| 12 | 67.245 | 4.70 | 1.85478 | 24.8 | 38.95 |
| 13 | 204.581 | 1.93 | | | 38.18 |
| 14 | −203.975 | 2.00 | 1.77250 | 49.6 | 38.13 |
| 15 | 112.360 | (Variable) | | | 37.58 |
| 16 (SP) | ∞ | 0.93 | | | 37.69 |
| 17* | 63.256 | 7.50 | 1.43875 | 94.7 | 37.86 |
| 18* | −102.807 | 18.84 | | | 37.41 |
| 19 | 435.031 | 2.00 | 1.77047 | 29.7 | 31.56 |
| 20 | 52.815 | 5.40 | | | 30.84 |
| 21 | 100.912 | 1.80 | 1.85478 | 24.8 | 31.50 |
| 22 | 58.660 | 4.00 | 1.80400 | 46.5 | 31.32 |
| 23 | 2875.153 | 0.07 | 1.58946 | 30.6 | 31.23 |
| 24* | 3462.436 | 3.00 | | | 31.22 |
| 25 | 73.524 | 4.00 | 1.53172 | 48.8 | 30.85 |
| 26 | −263.703 | (Variable) | | | 30.46 |
| 27 | −30268.917 | 2.00 | 1.92286 | 20.9 | 25.56 |
| 28 | −180.650 | 1.50 | 1.59522 | 67.7 | 25.19 |
| 29 | 46.455 | (Variable) | | | 24.05 |
| 30* | −202.629 | 4.00 | 1.51742 | 52.4 | 29.91 |
| 31* | −48.359 | (Variable) | | | 29.98 |
| 32 | −46.434 | 2.00 | 1.77047 | 29.7 | 29.44 |
| 33 | ∞ | (Variable) | | | 30.35 |
| 34 | 116.221 | 4.50 | 2.00069 | 25.5 | 47.77 |
| 35 | −942.807 | (Variable) | | | 47.71 |
| Image Plane | ∞ | | | | |

ASPHERIC DATA
17th Surface
K = 0.00000e+00 A 4 = −5.28875e−07 A 6 = 2.50706e−10
A 8 = −1.82712e−12 A10 = 1.86109e−15
18th Surface
K = 0.00000e+00 A 4 = 3.89908e−07 A 6 = 1.92869e−10
A 8 = −1.90820e−12 A10 = 2.20542e−15
24th Surface
K = 0.00000e+00 A 4 = 8.95598e−08 A 6 = 2.11795e−10
A 8 = −2.48501e−13 A10 = −2.29274e−16
30th Surface
K = 0.00000e+00 A 4 = 3.31118e−06 A 6 = 1.34769e−08 A 8 =
1.55479e−11 A10 = −6.82790e−14 A12 = 5.04607e−16
31st Surface
K = 0.00000e+00 A 4 = 2.02798e−06 A 6 = 1.40695e−08 A 8 =
1.16908e−11 A10 = −7.37995e−14 A12 = 5.64000e−16

VARIOUS DATA
ZOOM RATIO 2.41

| | WIDE | MIDDLE | TELE |
|---|---|---|---|
| Focal Length | 205.00 | 300.08 | 495.00 |
| Fno | 5.75 | 5.70 | 5.75 |
| Half Angle of View (°) | 6.02 | 4.12 | 2.50 |
| Image Height | 21.64 | 21.64 | 21.64 |
| Overall Lens Length | 350.00 | 350.00 | 350.00 |
| BF | 37.96 | 37.96 | 37.96 |
| d5 | 1.87 | 28.08 | 67.87 |
| d9 | 19.00 | 23.07 | 18.58 |
| d11 | 17.47 | 3.54 | 2.82 |
| d15 | 55.02 | 38.67 | 4.08 |
| d26 | 22.25 | 17.63 | 1.49 |
| d29 | 33.80 | 38.42 | 54.56 |
| d31 | 20.68 | 17.51 | 3.95 |
| d33 | 28.05 | 31.23 | 44.78 |
| d35 | 37.96 | 37.96 | 37.96 |
| EnPP | 174.37 | 246.93 | 316.03 |
| ExPP | −322.30 | −404.51 | −2267.76 |
| FPPP | 262.71 | 343.49 | 704.76 |
| RPPP | −167.04 | −262.12 | −457.04 |

LENS UNIT DATA

| LU | SS | FL | LCL | FPPP | RPPP |
|---|---|---|---|---|---|
| 1 | 1 | 210.87 | 25.10 | 7.29 | −9.90 |
| 2 | 6 | −1181.55 | 16.63 | 58.81 | 42.82 |
| 3 | 10 | −107.16 | 2.00 | 0.88 | −0.42 |
| 4 | 12 | −697.76 | 8.63 | 46.33 | 38.15 |
| 5 | 16 | 75.29 | 47.54 | 23.03 | −25.80 |
| 6 | 27 | −90.84 | 3.50 | 2.13 | 0.15 |
| 7 | 30 | 121.69 | 4.00 | 3.43 | 0.82 |
| 8 | 32 | −60.27 | 2.00 | −0.00 | −1.13 |
| 9 | 34 | 103.62 | 4.50 | 0.25 | −2.01 |

SINGLE LENS DATA

| Lens | Starting Surface | Focal Length |
|---|---|---|
| 1 | 1 | −309.89 |
| 2 | 2 | 232.79 |
| 3 | 4 | 270.23 |
| 4 | 6 | 417.71 |
| 5 | 8 | −297.73 |
| 6 | 10 | −107.16 |
| 7 | 12 | 115.37 |
| 8 | 14 | −93.53 |
| 9 | 17 | 90.50 |
| 10 | 19 | −78.20 |
| 11 | 21 | −167.19 |
| 12 | 22 | 74.43 |
| 13 | 23 | 28755.34 |
| 14 | 25 | 108.58 |
| 15 | 27 | 196.92 |
| 16 | 28 | −61.93 |
| 17 | 30 | 121.69 |
| 18 | 32 | −60.27 |
| 19 | 34 | 103.62 |

### Numerical Example 6

UNIT: mm
SURFACE DATA

| Surface | | | | | Effective |
|---|---|---|---|---|---|
| No. | r | d | nd | νd | Diameter |
| 1 | 105.360 | 1.40 | 1.90043 | 37.4 | 59.57 |
| 2 | 69.455 | 8.90 | 1.43875 | 94.7 | 58.08 |
| 3 | −868.468 | 0.20 | | | 57.50 |
| 4 | 61.830 | 8.00 | 1.43875 | 94.7 | 54.43 |
| 5 | 559.753 | (Variable) | | | 53.04 |
| 6 | 277.126 | 2.85 | 1.74951 | 35.3 | 37.90 |
| 7 | −332.438 | 0.20 | | | 36.58 |
| 8 | 186.764 | 1.00 | 1.65160 | 58.5 | 33.80 |
| 9 | 28.661 | 7.06 | | | 29.40 |
| 10 | −49.587 | 1.40 | 1.53775 | 74.7 | 28.58 |
| 11 | 98.790 | (Variable) | | | 28.76 |
| 12 | 49.722 | 4.20 | 1.85478 | 24.8 | 29.91 |
| 13 | −403.947 | 2.17 | | | 29.83 |
| 14 | −50.730 | 1.20 | 1.70154 | 41.2 | 29.79 |
| 15 | 231.172 | (Variable) | | | 30.42 |
| 16 (SP) | ∞ | 2.00 | | | 31.34 |
| 17* | 28.174 | 9.50 | 1.49700 | 81.5 | 33.97 |
| 18* | −72.384 | 1.50 | | | 33.53 |
| 19 | 82.780 | 1.40 | 1.77047 | 29.7 | 31.38 |
| 20 | 29.103 | 6.50 | | | 29.70 |
| 21 | 69.705 | 1.05 | 1.85478 | 24.8 | 30.26 |
| 22 | 35.448 | 5.75 | 1.80400 | 46.5 | 29.91 |
| 23 | −341.147 | 0.07 | 1.58946 | 30.6 | 29.68 |
| 24* | −314.258 | 2.30 | | | 29.67 |
| 25 | 42.116 | 4.60 | 1.59522 | 67.7 | 28.34 |
| 26 | −927.195 | (Variable) | | | 27.46 |
| 27 | 240.406 | 2.40 | 1.92286 | 20.9 | 24.63 |
| 28 | −124.672 | 1.10 | 1.69930 | 51.1 | 24.19 |
| 29 | 26.724 | (Variable) | | | 23.51 |
| 30* | −79.617 | 5.05 | 1.58313 | 59.4 | 28.76 |
| 31* | −28.066 | (Variable) | | | 29.64 |
| 32 | −39.959 | 1.30 | 1.77047 | 29.7 | 29.59 |
| 33 | ∞ | (Variable) | | | 30.96 |
| 34 | 72.168 | 3.30 | 2.00100 | 29.1 | 37.06 |
| 35 | 259.884 | (Variable) | | | 37.08 |
| Image Plane | ∞ | | | | |

ASPHERIC DATA
17th Surface
K = 0.00000e+00 A 4 = −6.16263e−06 A 6 = −1.53474e−09
A 8 = −2.43584e−12 A10 = −1.40767e−14
18th Surface
K = 0.00000e+00 A 4 = 3.35678e−06 A 6 = −1.23348e−09
A 8 = −4.73723e−13 A10 = −5.30385e−15
24th Surface
K = 0.00000e+00 A 4 = 4.39197e−07 A 6 = 7.06441e−10 A 8 =
6.93958e−13 A10 = −5.53266e−15
30th Surface
K = 0.00000e+00 A 4 = 8.42547e−06 A 6 = −3.26153e−08 A 8 =
2.30852e−10 A10 = −7.80280e−13 A12 = 3.43929e−16
31st Surface
K = 0.00000e+00 A 4 = 9.03474e−06 A 6 = −2.14445e−08 A 8 =
1.16123e−10 A10 = −1.92604e−13 A12 = −6.31632e−16

VARIOUS DATA
ZOOM RATIO 2.61

| | WIDE | MIDDLE | TELE |
|---|---|---|---|
| Focal Length | 56.00 | 100.15 | 146.00 |
| Fno | 2.90 | 2.90 | 2.90 |
| Half Angle of View (°) | 21.12 | 12.19 | 8.43 |
| Image Height | 21.64 | 21.64 | 21.64 |
| Overall Lens Length | 195.00 | 195.00 | 195.00 |
| BF | 37.12 | 37.12 | 37.12 |
| d5 | 1.48 | 24.29 | 36.74 |
| d11 | 9.95 | 2.96 | 1.20 |
| d15 | 29.51 | 13.68 | 3.00 |
| d26 | 1.00 | 3.96 | 5.20 |
| d29 | 19.52 | 16.57 | 15.32 |
| d31 | 2.17 | 4.13 | 2.36 |
| d33 | 7.84 | 5.88 | 7.65 |
| d35 | 37.12 | 37.12 | 37.12 |
| EnPP | 58.50 | 107.04 | 135.00 |
| ExPP | −90.36 | −79.47 | −82.76 |
| FPPP | 89.90 | 121.17 | 103.19 |
| RPPP | −18.88 | −63.03 | −108.88 |

LENS UNIT DATA

| LU | SS | FL | LCL | FPPP | RPPP |
|---|---|---|---|---|---|
| 1 | 1 | 115.32 | 18.50 | 4.57 | −8.19 |
| 2 | 6 | −31.31 | 12.51 | 6.59 | −3.52 |
| 3 | 12 | 267.60 | 7.57 | −19.31 | −22.83 |
| 4 | 16 | 34.09 | 34.67 | 16.47 | −14.81 |
| 5 | 27 | −49.20 | 3.50 | 2.33 | 0.41 |
| 6 | 30 | 71.74 | 5.05 | 4.75 | 1.68 |
| 7 | 32 | −51.86 | 1.30 | −0.00 | −0.73 |
| 8 | 34 | 98.94 | 3.30 | −0.63 | −2.26 |

SINGLE LENS DATA

| Lens | Starting Surface | Focal Length |
|---|---|---|
| 1 | 1 | −230.61 |
| 2 | 2 | 147.01 |
| 3 | 4 | 157.65 |
| 4 | 6 | 202.05 |
| 5 | 8 | −52.09 |
| 6 | 10 | −61.19 |
| 7 | 12 | 52.02 |
| 8 | 14 | −59.20 |
| 9 | 17 | 42.13 |
| 10 | 19 | −58.92 |
| 11 | 21 | −85.59 |
| 12 | 22 | 40.21 |
| 13 | 23 | 6757.25 |
| 14 | 25 | 67.80 |
| 15 | 27 | 89.24 |
| 16 | 28 | −31.38 |
| 17 | 30 | 71.74 |
| 18 | 32 | −51.86 |
| 19 | 34 | 98.94 |

Table 1 summarizes the values of inequalities (1) to (16) for each numerical example below. Table 2 illustrates changes (%) in the size of the imaging range on the object side in an in-focus state on an object at infinity and in an in-focus state on an object at a close distance at the wide-angle end (WIDE), an intermediate zoom position (MIDDLE), and a telephoto end (TELE) with an object distance of 3000 mm and an F-number of 22. Table 3 illustrates a half angle of view (°) in an in-focus state on an object at infinity and in an in-focus state on an object at a close distance.

TABLE 1

| | | Numerical Example | | | | | |
|---|---|---|---|---|---|---|---|
| Inequality | | 1 | 2 | 3 | 4 | 5 | 6 |
| (1) | fF2/fF1 | 1.155 | 1.085 | 1.160 | 0.786 | 0.663 | 1.054 |
| (2) | fFw/fw | −1.278 | −1.271 | −1.922 | −1.570 | −1.139 | −1.119 |
| (3) | fFT/fT | −1.392 | −1.218 | −3.931 | −5.061 | −4.463 | −0.923 |
| (4) | fF1/fRa | −1.468 | −1.479 | −1.076 | −1.339 | −1.207 | −1.443 |
| (5) | fF1/fi | −0.459 | −0.469 | −0.535 | −0.647 | −0.877 | −0.497 |
| (6) | fF2/fRb | −0.660 | −0.647 | −0.770 | −0.556 | −0.495 | −0.723 |
| (7) | βF1t/βF2t | 1.134 | 1.073 | 1.378 | 0.937 | 0.825 | 1.042 |
| (8) | \|besF1t\|/ | 2.512 | 2.338 | 2.601 | 2.020 | 2.197 | 2.063 |
| | \|besF2t\| | | | | | | |
| (9) | ST/TTL | 0.546 | 0.557 | 0.496 | 0.556 | 0.584 | 0.592 |
| (10) | fFt/fRt | −4.285 | −3.785 | −10.211 | −13.044 | −10.560 | −2.722 |
| (11) | \|mF2w\|/ | 1.025 | 0.924 | 0.940 | 1.195 | 1.546 | 0.704 |
| | \|mF1w\| | | | | | | |
| (12) | \|mF2t\|/ | 0.757 | 0.709 | 0.679 | 0.955 | 0.663 | 0.478 |
| | \|mF1t\| | | | | | | |
| (13) | SF2 | 1 | 1 | 1 | 1 | 1 | 1 |
| (14) | NdF2 | 1.770 | 1.770 | 1.770 | 1.770 | 1.770 | 1.770 |
| (15) | TTL/fT | 1.119 | 1.167 | 1.100 | 0.886 | 0.707 | 1.336 |
| (16) | BF/fi | 0.313 | 0.321 | 0.314 | 0.316 | 0.366 | 0.375 |

TABLE 2

| | Numerical Example | | | | | |
|---|---|---|---|---|---|---|
| | 1 | 2 | 3 | 4 | 5 | 6 |
| WIDE | 0.67 | 0.35 | −0.44 | −0.91 | −1.65 | 0.23 |
| MIDDLE | 1.74 | 1.36 | −0.81 | −1.74 | −2.85 | 0.93 |
| TELE | 4.50 | 2.90 | −1.37 | −2.25 | −0.93 | 1.84 |

TABLE 3

| | | Numerical Example | | | | | |
|---|---|---|---|---|---|---|---|
| | | 1 | 2 | 3 | 4 | 5 | 6 |
| WIDE | Infinity | 16.72 | 20.24 | 12.22 | 6.01 | 6.02 | 21.72 |
| | Close | 16.60 | 20.17 | 12.27 | 6.06 | 6.12 | 21.63 |
| MIDDLE | Infinity | 10.04 | 10.04 | 6.61 | 4.11 | 4.11 | 12.04 |
| | Close | 9.86 | 9.89 | 6.65 | 4.17 | 4.22 | 11.90 |
| TELE | Infinity | 6.22 | 6.70 | 4.22 | 3.12 | 2.49 | 8.24 |
| | Close | 5.92 | 6.48 | 4.26 | 3.19 | 2.51 | 8.06 |

### Image Pickup Apparatus

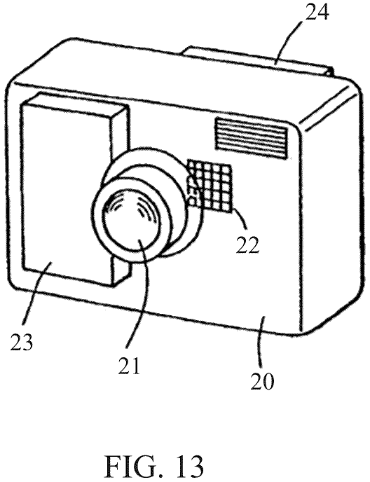

FIG. 13 illustrates a digital still camera as an image pickup apparatus using the zoom lens of any one of the above examples as an imaging optical system. Reference numeral 20 denotes a camera body, and reference numeral 21 denotes an imaging optical system including the zoom lens according to any one of Examples 1 to 6. Reference numeral 22 denotes an image sensor such as a CCD sensor or CMOS sensor that is built into the camera body 20 and captures the optical image (object image) formed by the imaging optical system 21. Reference numeral 23 denotes a recorder configured to record image data generated by processing the imaging signal from the image sensor 22, and reference numeral 24 denotes a rear display configured to display the image data.

By using the zoom lens according to each example, a camera having a reduced size and weight, and high optical performance can be obtained. The camera may be a single-lens reflex camera with a quick-turn mirror, or a mirrorless camera without a quick-turn mirror.

While the disclosure has described example embodiments, it is to be understood that some embodiments are not limited to the disclosed embodiments. The scope of the following claims is to be accorded the broadest interpretation so as to encompass all such modifications and equivalent structures and functions.

A zoom lens according to each example can reduce the size of a moving lens unit and suppress focus breathing.

This application claims priority to Japanese Patent Application No. 2023-193613, which was filed on Nov. 14, 2023, and which is hereby incorporated by reference herein in its entirety.

What is claimed is:

1. A zoom lens comprising, in order from an object side to an image side:
a front group consisting of a first lens unit having positive refractive power and a plurality of intermediate lens units, the plurality of intermediate lens units including one or more lens units having negative refractive power; and
a rear group consisting of an aperture stop and a plurality of lens units,
wherein during zooming from a wide-angle end to a telephoto end, the first lens unit and the lens unit closest to an object in the rear group are fixed and each of the plurality of intermediate lens units moves toward the image side, a distance between adjacent lens units among lens units included in the front group and the lens unit closest to the object in the rear group changes,
wherein the rear group includes a first focus lens unit and a second focus lens unit disposed on the image side of the first focus lens unit, the first focus lens unit and the second focus lens unit moving during focusing, and
wherein the following inequalities are satisfied:
$$0.2 \leq fF 2 / fF 1 \leq 2.$$
$$- 3 \leq fFw / fw < 0$$
where fF1 is a focal length of the first focus lens unit, fF2 is a focal length of the second focus lens unit, fFw is a focal length of the front group at the wide-angle end, and fw is a focal length of the zoom lens at the wide-angle end.

2. The zoom lens according to claim 1, wherein the aperture stop is disposed closest to the object in the rear group.

3. The zoom lens according to claim 1, wherein each of the first focus lens unit and the second focus lens unit moves toward the image side during focusing from an object at infinity to an object at a close distance.

4. The zoom lens according to claim 1, wherein the following inequality is satisfied:
$$- 6.5 \leq fFt / f t < 0.0$$
where ft is a focal length of the zoom lens at the telephoto end, and fFt is a focal length of the front group at the telephoto end.

5. The zoom lens according to claim 1, wherein the following inequality is satisfied:
$$- 2.0 \leq fF 1 / fRa \leq - 0.5$$
where is fRa is a focal length of a lens unit that is included in the rear group, and adjacent to and disposed on the object side of the first focus lens unit.

6. The zoom lens according to claim 1, wherein a final lens unit in the rear group closest to an image plane does not move during zooming and focusing, and
wherein the following inequality is satisfied:
$$- 2.0 \leq fF 1 / fi < 0.0$$
where fi is a focal length of the final lens unit.

7. The zoom lens according to claim 1, wherein a fixed lens unit that does not move during zooming and focusing is disposed between the first focus lens unit and the second focus lens unit, and
wherein the following inequality is satisfied:
$$- 2.0 \leq fF 2 / fRb \leq - 0.2$$
where f2 is a focal length of the second focus lens unit, and fRb is a focal length of the fixed lens unit.

8. The zoom lens according to claim 1, wherein the following inequality is satisfied:
$$0.5 \leq β F 1 t / β F 2 t \leq 3.$$
where βF1t is an imaging magnification of the first focus lens unit at the telephoto end, and βF2t is an imaging magnification of the second focus lens unit at the telephoto end.

9. The zoom lens according to claim 1, wherein the following inequality is satisfied:
$$1.5 \leq \vert besF 1 t \vert / \vert besF 2 t \vert \leq 5.$$
where βF1t is an imaging magnification of the first focus lens unit at the telephoto end, βF1Rt is a combined imaging magnification of one or more lens units on the image side of the first focus lens unit at the telephoto end, βF2t is an imaging magnification of the second focus lens unit at the telephoto end, βF2Rt is a combined imaging magnification of one or more lens units on the image side of the second focus lens unit at the telephoto end, besF1t is a focus sensitivity of the first focus lens unit at the telephoto end and expressed below, and besF2t is a focus sensitivity of the second focus lens unit at the telephoto end and expressed below:
$$besF 1 t - ( 1 - β F 1 {t}^{2} ) \times β F 1 {Rt}^{2}$$
$$besF 2 t - ( 1 - β F 2 {t}^{2} ) \times β F 2 R {t}^{2} .$$

10. The zoom lens according to claim 1, wherein the following inequality is satisfied:
$$0.4 \leq ST / TTL \leq 0.7$$
where ST is a length on an optical axis from the aperture stop to an image plane, TTL is a length on the optical axis from a surface of the zoom lens closest to the object to the image plane.

11. The zoom lens according to claim 1, wherein the following inequality is satisfied:
$$- 30 \leq fFt / fRt < 0$$
where fRt is a focal length of the front group at the telephoto end, and fRt is a focal length of the rear group at the telephoto end.

12. The zoom lens according to claim 1, wherein the following inequality is satisfied:
$$0.4 \leq \vert m F 2 w \vert / \vert m F 1 w \vert \leq 2. 0$$
where mF1w is a moving amount of the first focus lens unit during focusing from an object at infinity to an object at a close distance at the wide-angle end, and mF2w is a moving amount of the second focus lens unit during focusing from the object at infinity to the object at a close distance at the wide-angle end.

13. The zoom lens according to claim 1, wherein the following inequality is satisfied:
$$0.3 \leq \vert m F 2 t \vert / \vert m F 1 t \vert \leq 2. 0$$
where mF1t is a moving amount of the first focus lens unit during focusing from an object at infinity to an object at a close distance at the telephoto end, and mF2t is a moving amount of the second focus lens unit during focusing from the object at infinity to the object at a close distance at the telephoto end.

14. The zoom lens according to claim 1, wherein the second focus lens unit includes a single negative lens, and
wherein the following inequality is satisfied:
$$0.3 \leq SF 2 \leq 3.$$
where R1 is a radius of curvature of a surface on the object side of the negative lens, R2 is a radius of curvature of a surface on the image side of the negative lens, and SF2 is expressed as follows:
$$SF 2 = ( R 2 + R 1 ) / ( R 2 - R 1 ) .$$

15. The zoom lens according to claim 1, wherein the second focus lens unit includes a single negative lens, and
wherein the following inequality is satisfied:
$$1. 6 \leq NdF 2 \leq 2.0$$
where NdF2 is a refractive index of the negative lens for d-line.

16. The zoom lens according to claim 1, wherein the following inequality is satisfied:
$$0.5 \leq TTL / ft \leq 1.5$$
where ft is a focal length of the zoom lens at the telephoto end, and TTL is a length on an optical axis from a surface of the zoom lens closest to the object to an image plane.

17. The zoom lens according to claim 1, wherein the following inequality is satisfied:
$$0.2 \leq BF / fi \leq 0.6$$
where BF is a back focus of the zoom lens, and fi is a focal length of a final lens unit closest to an image plane.

18. The zoom lens according to claim 1, wherein two lens units closest to the object in the plurality of intermediate lens units include a positive lens and a negative lens arranged from the object side.

19. The zoom lens according to claim 1, wherein two lens unit closest to an image plane of the plurality of intermediate lens units include a positive lens and a negative lens arranged from the object side.

20. The zoom lens according to claim 1, wherein a part of the rear group is configured to move relative to an optical axis as an image stabilizing unit.

21. The zoom lens according to claim 1, wherein the plurality of intermediate lens units include, in order from the object side to the image side, a second lens unit having negative refractive power, a third lens unit having negative refractive power, and a fourth lens unit having positive refractive power,
wherein the plurality of lens units in the rear group include, in order from the object side to the image side, a fifth lens unit having positive refractive power, a sixth lens unit having negative refractive power as the first focus lens unit, a seventh lens unit having positive refractive power, an eighth lens unit having negative refractive power as the second focus lens unit, and a ninth lens unit having positive refractive power.

22. The zoom lens according to claim 1, wherein the plurality of intermediate lens units include, in order from the object side to the image side, a second lens unit having negative refractive power, a third lens unit having negative refractive power, and a fourth lens unit having negative refractive power, and
wherein the plurality of lens units in the rear group include, in order from the object side to the image side, a fifth lens unit having positive refractive power, a sixth lens unit having negative refractive power as the first focus lens unit, a seventh lens unit having positive refractive power, an eighth lens unit having negative refractive power as the second focus lens unit, and a ninth lens unit having positive refractive power.

23. The zoom lens according to claim 1, wherein the plurality of intermediate lens units includes, in order from the object side to the image side, a second lens unit having negative refractive power, and a third lens unit having positive refractive power, and
wherein the plurality of lens units in the rear group includes, in order from the object side to the image side, a fourth lens unit having positive refractive power, a fifth lens unit having negative refractive power as the first focus lens unit, a sixth lens unit having positive refractive power, a seventh lens unit having negative refractive power as the second focus lens unit, and an eighth lens unit having positive refractive power.

24. An image pickup apparatus comprising:
a zoom lens; and
an image sensor configured to capture an object image via the zoom lens,
wherein a zoom lens consists of, in order from an object side to an image side:
a front group consisting of a first lens unit having positive refractive power and a plurality of intermediate lens units, the plurality of intermediate lens units including one or more lens units having negative refractive power; and
a rear group consisting of an aperture stop and a plurality of lens units,
wherein during zooming from a wide-angle end to a telephoto end, the first lens unit and the lens unit closest to an object in the rear group are fixed and each of the plurality of intermediate lens units moves toward the image side, a distance between adjacent lens units among lens units included in the front group and the lens unit closest to the object in the rear group changes,
wherein the rear group includes a first focus lens unit and a second focus lens unit disposed on the image side of the first focus lens unit, the first focus lens unit and the second focus lens unit moving during focusing, and
wherein the following inequalities are satisfied:
$$0.2 \leq fF 2 / fF 1 \leq 2.$$
$$- 3 \leq fFw / fw < 0$$
where fF1 is a focal length of the first focus lens unit, fF2 is a focal length of the second focus lens unit, fFw is a focal length of the front group at the wide-angle end, and fw is a focal length of the zoom lens at the wide-angle end.
